(19) United States
(12) Patent Application Publication
(10) Pub. No.: US 2012/0150570 A1
(43) Pub. Date: Jun. 14, 2012

(54) RISK ASSESSMENT/MEASUREMENT SYSTEM AND RISK-BASED DECISION ANALYSIS TOOL

(76) Inventors: Ali Samad-Khan, Stamford, CT (US); Sabyasachi Guharay, Fairfax Station, VA (US); Joseph Tieng, Fair Lawn, NJ (US)

(21) Appl. No.: 13/391,062

(22) PCT Filed: Aug. 20, 2010
(86) PCT No.: PCT/US2010/046204

§ 371 Date: Feb. 17, 2012

Related U.S. Application Data
(60) Provisional application No. 61/274,720, filed on Aug. 20, 2009.

(51) Int. Cl. G06Q 40/08; G06Q 10/00

(52) U.S. Cl. 705/4; 705/7.28

(57) ABSTRACT

The present invention relates to a method and system for more accurately and reliably assessing/measuring risk, and is applicable to all areas of risk management including market, credit, operational and business/strategic risk. An additional aspect of the invention contemplates transforming the resulting risk metrics into risk-based economic capital and/or into decision variables, which can be used to make informed risk-based decisions.

### BACKGROUND OF THE INVENTION

THIS invention relates to a method and system for more accurately and reliably assessing/measuring risk; and is applicable to all areas of risk management including market, credit, operational and business/strategic risk. An additional aspect of the invention contemplates transforming the resulting risk metrics into risk-based economic capital and/or into decision variables, which can be used to make informed risk-based decisions.

Most traditional market, credit and operational risk models systematically underestimate risk because they do not adequately incorporate the impact of rare “black swan” events. In market and credit risk management this is evidenced by the fact that the so called “one in a 100 year” events seem to occur every 10-15 years. In operational risk this is evidenced by the fact that a firm's internal loss experience alone is insufficient to accurately measure its exposure to the types of events that impact one in a 100 firms in an average year. The present invention enables data and other types of information gathered either over long time periods (multiple economic cycles) or across multiple firms in an industry (data from different sources) to be incorporated into the analysis in an objective, transparent and theoretically valid manner. Therefore, this method can reliably produce, for example, a 99% level risk estimate, based on a one year time horizon, which is much more comparable to the true one in a 100 year event.

Many traditional risk models also rely exclusively on historical empirical “hard” data. This is because they do not allow for “soft” data or information based on “expert opinion” to be incorporated into the analysis in an objective or theoretically valid manner. As a result, these backward looking models do not accurately reflect a firm's risk profile when the risk profile changes. Using obsolete information for risk analysis can be misleading and dangerous. An aspect of the present invention enables the transformation of raw loss data into 1-in-N year loss exceedence values. Transforming raw loss data into 1-in-N year loss exceedence values is comparable to converting to a “common denominator.” As a result any such loss data can be combined with loss data from other sources—even when that data has been collected over a different time period and/or from numerous firms. Using this method allows not only incorporation of data from different sources into the analysis, but also updating of the risk profile with soft data gathered over very long time periods and/or information obtained from expert opinion in an objective, transparent and theoretically valid manner.

Presently available management and accounting systems do not provide mechanisms for easily understandable and/or transparent assessment/measurement of risk adjusted profit. Biased models create “risk-reward arbitrage” opportunities, allowing unethical managers to deliberately engage in high-risk activities while appearing to operate within stakeholder risk tolerances (principal-agent risk). The computer implemented method and system associated with this invention enables the calculation of a “cost of risk” figure, which is treated as an additional expense item. Including this incremental expense item in profitability calculations allows the estimation of risk-adjusted profitability—in an objective, transparent and theoretically valid manner—in addition to ordinary accounting profitability.

The present invention addresses the need for a system and methodology that accurately measures risk at a high confidence level. It also facilitates objective, risk-based decision analysis and risk sensitivity analysis and provides for greater transparency in the business decision-making process.

### SUMMARY OF THE INVENTION

According to a first aspect of the invention, there is provided a computer implemented system for estimating the risk of loss for a specified time period, the system comprising:
an input module, operable to retrieve and/or receive manually, input information relating to a plurality of observed and/or anticipated loss event occurrences, the input information providing a plurality of loss amount thresholds and the frequency of loss event occurrences at the plurality of loss amount thresholds;
an optimization module, operable to generate ALECs based on three or more parameters, the parameters comprising two or more severity parameters from an assumed loss severity distribution and an average loss frequency parameter for the specified time period, the optimization module:
   (a) generating one or more initial value sets of the parameters, the initial value sets being provided as pre-determined values and/or provided randomly from a range and/or received manually, the range being pre-determined and/or received manually,
   (b) generating a ALEC for each of the value sets of the parameters,
   (c) calculating a weighted error test statistic to measure one or more differences at each loss amount threshold, and/or the aggregated differences, between each generated ALEC and the input information,
   (d) where one or more of the differences between any one or more of the ALECs and the input information show an improvement in the weighted error statistic greater than a predetermined rate or where steps (b) to (c) have been repeated less than a predetermined number of times, repeating steps (b) to (c) with new value sets of the parameters, the new value sets of the parameters being calculated to attempt to reduce the error test statistic for those ALECs,
   (e) determining, from the ALECs not being affected by step (d), the overall best fit ALEC based on a comparison of the error test statistics calculated in step (c), and
   (f) where the differences between the overall best fit ALEC and the input information exceeds a predetermined precision requirement, and where steps (c) to (e) have been carried out less than a predetermined number of times, repeating steps (c) to (e) with a new weighted error test statistic, thereby providing an estimation ALEC;
wherein the estimation ALEC represents one unique combination of the average frequency of loss event occurrences for the specified time period and the parameters of the assumed loss severity distribution that best approximate the input information; thereby, from the estimation ALEC, the risk of loss may be determined.

The risk of loss for a given level of loss is described in terms of loss frequency information and expressed as the number of expected loss events in for the specified time period, or expressed as the probability of one or more loss events occurring in the specified time period or expressed as the expected time period between expected loss events, the expected time period between expected loss events being expressed as 1-in-N years.

The frequency of loss event occurrences is generally the number of loss event occurrences within an observation period, the average number of events for the specified time period, or the time period between loss event occurrences expressed as 1-in-N time periods.

In a preferred embodiment, the frequency of loss event occurrences is assumed to be Poisson distributed, enabling the determination of the estimated individual loss frequency distribution for the specified time period and the individual loss severity distribution.

Generally, severity is assumed to have a normal or lognormal distribution.

Typically, the input module is operable to accept hard data, soft data and/or expert opinion.

In a preferred embodiment, the optimization module applies a weighted minimum distance analysis routine, thereby exaggerating the test error statistic and placing greater emphasis on the tail portion of the approximated ALEC and severity distribution.

The weighted minimum distance analysis routine may further exaggerate the test error statistic by applying the log value of the aggregated errors.

Prior to application of the optimization module, loss information collected by the input module may be scaled by dividing all losses by the lowest loss threshold, and after application of the optimization module the mean severity parameter is scaled back.

Preferably, means for undertaking Monte Carlo based simulation are provided to estimate the aggregated expected loss, and/or the aggregated unexpected loss at a high confidence level.

Additional means to calculate the aggregated cost of risk and/or risk adjusted profitability and/or economic risk of capital may be provided.

Risk-based decision analysis may be conducted, the analysis comparing one or more attributes of the estimated ALECs and/or the simulation results derived from the original input information with one or more hypothetical scenarios, and determining the sensitivities of one or more variances in the hypothetical input information and/or parameters and/or other information for the scenarios. Other information may comprise loss amount limits and/or risk tolerance levels and/or cost of capital and/or cost of controls and/or projected benefit/profit and/or cost and coverage of insurance. The analysis may be risk-reward analysis and/or risk-control and/or risk-transfer and/or cost/benefit analysis.

Typically, the specified time period is one year.

According to a second aspect of the invention, there is provided a computer implemented method for estimating the risk of loss for a specified time period, the method comprising the steps of:
retrieving and/or receiving manually, input information relating to a plurality of observed and/or anticipated loss event occurrences, the input information providing a plurality of loss amount thresholds and the frequency of loss event occurrences at the plurality of loss amount thresholds;
generating ALECs based on three or more parameters, the parameters comprising two or more severity parameters from an assumed loss severity distribution and an average loss frequency parameter for the specified time period, and optimizing the ALECs by:
   (a) generating one or more initial value sets of the parameters, the initial value sets being provided as pre-determined values and/or provided randomly from a range and/or received manually, the range being pre-determined and/or received manually,
   (b) generating a ALEC for each of the value sets of the parameters,
   (c) calculating a weighted error test statistic to measure one or more differences at each loss amount threshold, and/or the aggregated differences, between each generated ALEC and the input information,
   (d) where one or more of the differences between any one or more of the ALECs and the input information show an improvement in the weighted error statistic greater than a predetermined rate or where steps (b) to (c) have been repeated less than a predetermined number of times, repeating steps (b) to (c) with new value sets of the parameters, the new value sets of the parameters being calculated to attempt to reduce the error test statistic for those ALECs,
   (e) determining, from the ALECs not being affected by step (d), the overall best fit ALEC based on the error test statistics calculated in step (c), and
   (f) where the differences between the overall best fit ALEC and the input information exceeds a predetermined precision requirement, and where steps (c) to (e) have been carried out less than a predetermined number of times, repeating steps (c) to (e) with a new weighted error test statistic, thereby providing an estimation ALEC;
wherein the estimation ALEC represents one unique combination of the average frequency of loss event occurrences for the specified time period and the parameters of the assumed loss severity distribution that best approximate the input information;
   thereby, from the estimation ALEC, the risk of loss may be determined.

According to a third aspect of the invention, there is provided a machine-readable medium having stored thereon data representing sets of instructions which, when executed by a machine, cause the machine to perform operations for estimating the risk of loss for a specified time period, the operations comprising:
retrieving and/or receiving manually, input information relating to a plurality of observed and/or anticipated loss event occurrences, the input information providing a plurality of loss amount thresholds and the frequency of loss event occurrences at the plurality of loss amount thresholds;
generating ALECs based on three or more parameters, the parameters comprising two or more severity parameters from an assumed loss severity distribution and an average loss frequency parameter for the specified time period, and optimizing the ALECs by:
   (a) generating one or more initial value sets of the parameters, the initial value sets being provided as pre-determined values and/or provided randomly from a range and/or received manually, the range being pre-determined and/or received manually,
   (b) generating a ALEC for each of the value sets of the parameters,
   (c) calculating a weighted error test statistic to measure one or more differences at each loss amount threshold, and/or the aggregated differences, between each generated ALEC and the input information,
   (d) where one or more of the differences between any one or more of the ALECs and the input information show an improvement in the weighted error statistic greater than a predetermined rate or where steps (b) to (c) have been repeated less than a predetermined number of times, repeating steps (b) to (c) with new value sets of the parameters, the new value sets of the parameters being calculated to attempt to reduce the error test statistic for those ALECs,
   (e) determining, from the ALECs not being affected by step (d), the overall best fit ALEC based on the error test statistics calculated in step (c), and
   (f) where the differences between the overall best fit ALEC and the input information exceeds a predetermined precision requirement, and where steps (c) to (e) have been carried out less than a predetermined number of times, repeating steps (c) to (e) with a new weighted error test statistic, thereby providing an estimation ALEC;
wherein the estimation ALEC represents one unique combination of the average frequency of loss event occurrences for the specified time period and the parameters of the assumed loss severity distribution that best approximate the input information;
   thereby, from the estimation ALEC, the risk of loss may be determined.

According to a fourth aspect of the invention, there is provided a computer implemented method for estimating the risk of loss for a specified time period, the method comprising the steps of:
retrieving and/or receiving manually, input information relating to a plurality of observed and/or anticipated loss event occurrences, the input information providing a plurality of loss amount thresholds and the frequency of loss event occurrences at the plurality of loss amount thresholds;
generating one or more ALECs based on three or more parameters, the parameters comprising two or more severity parameters from an assumed loss severity distribution and an average loss frequency parameter for the specified time period; and
optimizing the ALECs by choosing an estimation ALEC from the one or more ALECs, wherein the estimation ALEC represents one unique combination of the average frequency of loss event occurrences for the specified time period and the parameters of the assumed loss severity distribution that best approximate the input information;
   wherein the risk of loss is determined from the estimation ALEC.

Embodiments of the invention are described in detail in the following passages of the specification, which refer to the accompanying drawings.

### BRIEF DESCRIPTION OF THE DRAWINGS

FIG. 1 is a typical probability density function (PDF) for a given class of events (e.g., internal fraud).

FIGS. 2(a) & (b) are histograms showing wind-driven and tsunami-driven wave data in exaggerated and more realistic formats;

FIG. 3(a) is a theoretical PDF superimposed over a histogram of data points collected at a non-zero threshold (in the Figure it is implied that the PDF has been estimated using a method that can accommodate truncated data);

FIG. 3(b) shows two theoretical PDFs and a histogram; the first PDF is the PDF of FIG. 3(a), the second PDF is an adjusted PDF reflecting the addition of three data points from some other source;

FIG. 4 is a graph representing an early (flawed) attempt of expressing loss information in terms of expected annual frequency (by State Street Bank);

FIG. 5 shows graphs representing PDF, Cumulative Distribution Function (CDF) and Loss Exceedence Curve (LEC);

FIG. 6(a) is a graph representing an example of an annualized loss exceedence curve (ALEC), where the Y-axis is expressed as average number of events during the specified time period (this graph is referred to as ALEC1A);

FIG. 6(b) is a graph representing a second example of a single event ALEC, where the Y-axis is expressed as 1-in-N year occurrences (this graph is also referred to as ALEC1B); the total Years in the observation period divided by number of events during the observation period equals N years;

FIG. 6(c) is a graph representing a third example of a single event ALEC, where the Y-axis is represented as Probability (this graph is also referred to as ALEC2);

FIG. 7 is a table showing the relationship between Probability and 1-in-N years where event frequency follows a Poisson distribution;

FIG. 8 shows graphically the relationship of the LEC with an ALEC function;

FIG. 9 is a flowchart of a preferred embodiment of the optimization routine applied in the optimization module;

FIGS. 10(a)-(c) show spreadsheets of results provided from a simple optimization routine;

FIGS. 11-15 shows screenshots of a test comparing application of an aspect of the present invention with an extreme value distribution (such as a Generalized Pareto Distribution, GPD);

FIG. 16 is a table showing data in respect of tsunamis that have taken place in the past several hundred years and their associated magnitudes (measured in human lives lost);

FIG. 17 is a version of the table of FIG. 16, where the data has been normalized and culled;

FIG. 18 is a representation of the data provided in FIG. 17, converted into 1-in-N years;

FIG. 19 shows that it is possible to use information contained in an ALEC to derive a unique set of frequency and severity distributions; and

FIGS. 20-32 show screenshots of results derived in respect of embodiments described.

The illustrations are intended to provide a general understanding of the concepts described and the structure of various embodiments, and they are not intended to serve as a complete description of all the elements and features of methods and systems that might make use of the structures or concepts described herein. Many other embodiments will be apparent to those of skill in the art upon reviewing the description. Other embodiments may be utilized and derived therefrom, such that structural and logical substitutions and changes may be made without departing from the scope of this disclosure.

It should also be appreciated that the figures are merely representational, and are not be drawn to scale and certain proportions thereof may be exaggerated, while others may be minimized. Accordingly, the specification and drawings, together with any examples, are to be regarded in an illustrative rather than a restrictive sense.

### DESCRIPTION OF EMBODIMENTS OF THE INVENTION

Risk is a metric, indicative of the level of exposure to loss at an accepted level of uncertainty. At present most risk models fail to measure risk accurately at a high confidence level, such as a level of 99%, for a given time horizon, such as a one year time horizon. Modeling risk at a 99% level, with a one year time horizon, means estimating the level of loss at which there is only a 1% chance of sustaining a larger loss in any one year period (100%−99%=1%). For single event loss analysis, this is the equivalent of determining the magnitude of a one in a hundred year event. For aggregate loss analysis, this is the equivalent of determining the magnitude of cumulative losses that would occur only once in a hundred years.

The dramatic failure of the Long-Term Capital Management (LTCM) hedge fund in the late 1990s and the more recent public failures of financial industry giants, such as AIG, Lehman Brothers and Bear Sterns, can largely be attributed to the utilization of flawed risk models. However, these models may also be used as a convenient scapegoat. One could argue, for example, that in many cases senior officers recognized the “risk-reward arbitrage” opportunities created by the biased models and used this information to their advantage. Consequently, because high risk activities were likely to result in high rewards, and because they knew their models underrepresented the level of the accompanying risk, managers knowingly engaged in irresponsible, high risk strategies. As a result, these managers were surreptitiously able to take risks that were well beyond the actual tolerance level of the stakeholders, such as depositors, shareholders and bondholders, while taking refuge in their flawed models to justify the legitimacy of their actions. (Because many of these organizations were eventually bailed out by the US government, the ultimate stakeholders turned out to be the US taxpayers.)

Even on a less cynical assessment, because the managers' performance is often benchmarked against peers, irresponsible behavior at one organization can lead to a “follow the herd” mentality, causing widespread acceptance of a bad practice. Therefore even one instance of a bad practice has the potential to cause an industry trend. The threat of such a trend is often referred to as systemic risk (because in the banking industry an increase in risk across the entire banking system is referred to as systemic risk).

Virtually all models in use today, including the model most financial institutions currently use in market and credit risk management, suffer from the same problems as those that caused or contributed to the 2008 global financial crisis.

The present invention applies to all areas of risk management including market, credit, operational and business/strategic risk. Market risk is, for example, the risk of loss in the market value of a portfolio. Operational risk is, for example, the (risk of loss from operational failure, such as people, processes, systems, external events. Credit risk is, for example, the risk of counterparty default loss, where the other party is unable or unwilling to meet specific contractual obligations. Business/strategic risk is, for example, the risk of loss from an unforeseeable change in the macro-economic environment. In particular, using the methodologies of the present invention, statistical model parameters for loss frequency and severity can be derived by fitting observed loss data, or information on observed and/or anticipated potential losses obtained from expert opinion, to an ALEC.

The computer implemented programs/systems associated with this invention also enable the calculation of other relevant metrics, and these subsequently derived metrics can be used as a basis for estimating risk-based economic capital and/or to make informed risk based decisions, e.g., risk-reward, risk-control and risk-transfer optimization decisions. When used in combination with an ultra-high speed Monte Carlo simulation engine, these computer programs allow executives to transform the raw data into key decision metrics virtually instantaneously (sometimes in a few seconds). Thus, not only do these programs make it possible for executives to make informed risk-based business decisions, but they allow then to do so in real time.

The following paragraphs explain the numerous technical and practical benefits of the present invention:
1. Most traditional market, credit and operational risk models systematically underestimate risk because they do not adequately incorporate the impact of rare “black swan” events. In market and credit risk management this is evidenced by the fact that the so called “one in a 100 year” events seem to occur every 10-15 years. In operational risk this is evidenced by the fact that a firm's internal loss experience alone is insufficient to accurately measure exposure to the types of events that impact one in a 100 firms in an average year.
   The present invention makes it possible for data gathered either over long time periods (multiple economic cycles) or across multiple firms in an industry (data from different sources) to be incorporated into the analysis in an objective, transparent and theoretically valid manner. Therefore, this method can produce, for example, a 99% level risk estimate, based on a one year time horizon, which is much more comparable to the true one in a 100 year event.
2. Many traditional risk models also rely exclusively on historical empirical “hard” data. This is because they do not allow for “soft” data or information based on “expert opinion” to be incorporated into the analysis in an objective or theoretically valid manner. Hard data is data based on empirical observations obtained through a comprehensive and complete data collection process. Soft data is data based on empirical observations, but were the process is not fully comprehensive or complete. Expert opinion is information based on intuitive analysis of data gained from multiple sources and may include qualitative and quantitative information. As a result of the exclusive reliance on hard data, these backward looking models do not accurately reflect a firm's risk profile when the risk profile changes. Using obsolete information for risk analysis can be misleading and dangerous.
   An aspect of the present invention enables the transformation of raw loss data into 1-in-N year loss exceedence values. Expressing loss exceedences in terms of a common N year period is the modeling equivalent of converting to a common denominator. In addition, when a loss is associated with a 1-in-N year occurrence it can be connected to a probability of occurrence. Using this method allows not only incorporation of data from different sources into the analysis, but also updating of the risk profile with soft data gathered over very long time periods and/or information obtained from expert opinion in an objective, transparent and theoretically valid manner.
3. Biased models create “risk-reward arbitrage” opportunities, allowing unethical managers to deliberately engage in high-risk activities while appearing to operate within stakeholder risk tolerances (principal-agent risk). This was perhaps one of the most important factors contributing to the 2008 global financial crisis.
   The computer implemented method and system associated with this invention enables the calculation a “cost of risk” figure, which is treated as an additional expense item. Including this incremental expense item in profitability calculations allows the estimation of risk-adjusted profitability in addition to ordinary accounting profitability. If large publicly traded corporations were to require their managers to make business decisions a on risk-adjusted basis there would be much greater transparency in the decision making process. This would reduce information asymmetries between executives (agents) and stakeholders (depositors, stockholders and bondholders) and reduce the opportunity for executives to engage in activities which may benefit them personally, but which are not in the best interests of the stakeholders. For this process to work, however, the risk figures would have to be independently validated and saved indefinitely. In addition, managers would have to know they would be held accountable for making irresponsible decisions when its discovered that they knew or should have known they were exposing the firm to excessive risk. (This would reduce the incentive for making bad decisions.)
4. Because performance is generally benchmarked against peers, irresponsible behavior at one organization can lead to a “follow the herd mentality” and cause an industry trend (i.e., systemic risk).
   The computer implemented method and system associated with this invention enables ethical managers to show evidence, where such is the case, that investing in certain popular businesses may not be in the long term interest of the organization. Thus the use of computer implemented software incorporating the methodologies of the present invention can mitigate the potential for systemic risk. (Systemic risk refers to a contagion effect across an entire system or industry, such as the banking system/industry.)
5. The language of risk management has become too complex for most senior executives and board of directors to validate the business assumptions underlying their company's risk models. Therefore, most senior executives simply assume that with respect to risk management the business managers and risk function are upholding their fiduciary responsibilities.
   The methodology of the present invention represents risk information as a single event 1-in-N Year loss exceedence curve. This translates a complex concept into something even those with only a rudimentary understanding of risk management are able to comprehend. In particular, an ALEC curve describes how much risk a business opportunity represents, because the information is presented in plain language. For example, “This strategy is expected to produce at least one loss in excess of $X every Y years on average.” By using the ALEC method the need to use esoteric and non-intuitive concepts such a “Student T copulas” or “Vega risk” is obviated.

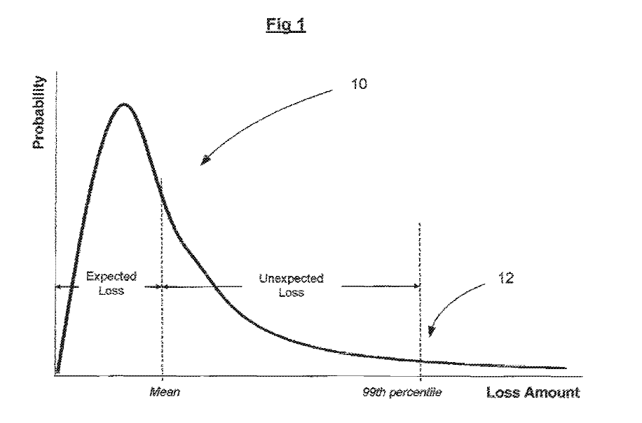

FIG. 1 shows a typical PDF for a given risk class (e.g., internal fraud), based on historical data. This figure shows that the “expected loss” is the probability weighted mean loss (or average severity) and the “unexpected loss” is the difference between the expected loss and the total risk exposure at the target confidence level (show here as 99%).

It can be seen that the PDF has, broadly speaking, a body portion 10 and a tail portion 12. Accurate modeling of the tail portion is critical in risk management, because estimating both the expected loss and the unexpected loss (the risk) is critically dependent on accurately understanding the relative probabilities in large loss region (the expected loss is the average loss, but this also includes the contribution of the large losses; for example, in discrete terms, a one in a hundred year tsunami that kills 500,000 people will contribute 5,000 deaths to the probability weighted mean (500,000/100=5,000).). However, this is generally not possible when—in the case of market and credit risk—one only has data from a short period of time, covering only one economic cycle, or—in the case of operational risk—one only has data from one firm gathered during a short period of time, where that firm has not experienced a sufficient number of non-normal events.

At present most financial risk models calculate Value at Risk (VaR) based on a one year time horizon for a specified confidence level. In market risk management this is typically undertaken by using a few years of historical data, estimating the volatility of daily securities price changes, and fitting this information to a parametric distribution. This is generally done by using a normal distribution, which is parameterized by mean (μ) and standard deviation (σ). However, other distributions are also used

Using this information, a daily VaR can be calculated, or a VaR with a one day time horizon. By assuming the data are independent and identically distributed (i.i.d.), and by making other commonly used assumptions, one can then extrapolate an annual VaR (a VaR with a one year time horizon). In such cases, converting the daily standard deviation to an annualized standard deviation can then accomplished by scaling the volatility parameter, i.e., multiplying the daily standard deviation by the square root of the number of trading days in a year. Calculating an annualized VaR is necessary because many organizations want to calculate (risk) economic capital with a one year time horizon and also because this information has relevance to senior management, regulators and other interested parties.

Modeling risk with only a few years of loss data is now very common and very rarely do analysts ponder or revisit the key assumptions underlying this approach. One critical assumption underlying all such models is the i.i.d. assumption; in particular, the assumption that the loss data are identically distributed. When this assumption is not valid, i.e., where the data are not homogenous, the models can produce spurious and misleading results.

Consider the following example. Suppose the height of ocean waves is to be modeled and it is assumed that all wave data are i.i.d. In this case the assumption provides that normal, wind-driven waves have the same properties as earthquake-driven tsunami waves. Now, suppose normal, wind-driven ocean waves occur in the tens of thousands each day and have a mean height of three feet and standard deviation of five feet. Also suppose major earthquake-driven tsunamis take place once every twenty years and have a mean height of thirty feet and a standard deviation of thirty feet.

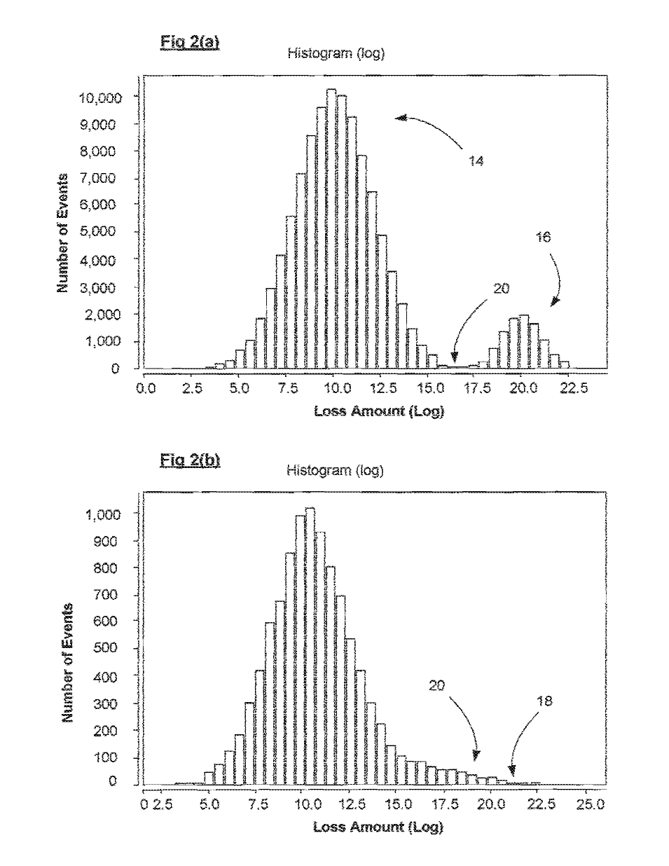

FIG. 2(a) is a histogram that shows this general concept graphically for wind-driven and tsunami-driven waves (note that the number of tsunami waves is overrepresented for illustrative purposes). If an analysis were based on a five year data sample, and no tsunamis occurred during this time period, the model may indicate that a 1-in-100 year event was a wave of height 30 feet, when in reality the true 1-in-100 year event may be a wave with a height of about 150 feet (which can only be estimated when the impact of tsunamis is included).

To a large extent, this explains why events that are expected only once every 100 years in fact take place much more frequently. One reason this is common is that many risk analysts believe that data sufficiency is more a function of the number of data points than the number of years (economic cycles) in the observation period. But also, absent the methodologies of the present invention, there is no objective, transparent and theoretically valid method of including information from multiple economic cycles into the analysis, because only hard data can be used. And such data does not generally exist beyond one or two economic cycles.

The methodology of the present invention applies a different approach to the traditional methods used in risk management; and it will become evident that where the goal is to measure risk, at a high confidence level, for a one year time horizon, data requirements must be specified not in terms of the number of data points, but rather in terms of the number of years in the observation period. As a result, models that try to extrapolate the shape of the high-risk tail portion 12 using data that represents the body portion 10 of the distribution, without any incorporation of longer term rare events, will be recognized as being invalid and will eventually become obsolete. In addition, models that can use soft data in a theoretically valid method will replace models that can only use hard data.

The methodology of the present invention may be used in various applications, including but not being limited to the following:
1. Calculating economic capital for all risks: To estimate risk-based economic capital at a high confidence level (e.g. 99%), for a one year time horizon, for all risks, for example, market risk, credit risk, operational risk and business/strategic risk.
2. Facilitating risk-based decision analysis: To measure the financial viability of a business proposition, through cost-benefit analysis, on a risk-adjusted basis.
3. Creating greater transparency: To create greater transparency in risk management by requiring key decision-makers to state or validate specific tail risk assumptions, with respect to strategic and tactical decisions, in non-technical terms.

As is evident from the above wave/tsunami example, where the goal is to measure risk at a 99% level, for a one year time horizon, and where the data are not i.i.d., ten million hard data points collected over a five year period are much less useful than a few soft observations over a one hundred year period.

The wave/tsunami example, while an extreme example, clearly illustrates the dangers of ignoring the i.i.d. assumption. In the FIG. 2(a) it can be seen that the data is not homogeneous, with considerable hard data information provided relating to wind-driven waves 14, and considerably less soft data information for tsunami waves 16. FIG. 2(b) reflects a more realistic depiction of wave data histogram (where there are many more wind-driven waves than tsunami-driven waves). The histogram value at 18 in FIG. 2(b) represents the true 99% level ocean wave (accounting for wind-driven and tsunami-driven waves); in comparison the histogram value at 20 is the 99% level wind-driven (only) ocean wave, being about five times lower than when tsunamis are considered.

The Value at Risk (VaR), as it is currently applied in market and credit risk, can be a useful metric for measuring short-term (daily/weekly) portfolio risk, but it should be apparent that it is wholly inadequate for measuring long term volatility as it does not account for rare events. This is because one cannot extrapolate long-term risk measures using the methods in place today. Global economic and other macro forces do not fully manifest themselves in daily market movements, and “losers” are regularly factored out of market indices. For example, Enron, WorldCom, General Motors and Lehman Brothers are not reflected in current market return indices. Moreover, the indices themselves are moving targets at times.

If the goal of modeling a 99% level VaR was to calculate a one in a hundred year event, it would be necessary to factor in the frequency of economic shocks every hundred years and their corresponding severity. Under an actuarial framework, each economic environment would represent a different non-homogenous distribution and there would be recognition that the 99% level event across all economic cycles may be several times higher that of the 99% level event in a “normal” or relatively benign economic environment. Recall that the 99% level ocean wave is actually equivalent to a moderately large tsunami which is many times larger than the 99% level wind-driven wave.

Actuarial science is frequently used to model aggregate loss distributions; where the goal is to measure cumulative loss exposure and not only the exposure to just one single loss. To estimate cumulative loss distributions actuaries use frequency and single-event severity distributions. Frequency can refer to the number of events that occur within a given observation time period, but often means the average number of events for a specified time period. Empirical evidence suggests that frequency tends to follow a Poisson process, which is parameterized by mean and variance. A Poisson distribution is a special case of the Poisson process, because in this distribution the mean is equal to the variance. Thus, the Poisson distribution is effectively a one parameter distribution. Modeling annual frequency using a Poisson distribution requires much less data than does modeling with many other distributions because with the Poisson distribution one needs only enough data to estimate the mean—the average number of events expected to take place in a year.

A severity distribution is a probabilistic representation of single-event loss magnitude. One important feature of the severity distribution is that it has no time element—therefore it represents relative probabilities. A severity distribution is often illustrated as a probability density function (PDF). Traditional actuarial modeling requires fitting data retrieved from a database to a PDF and this is often accomplished by using a process called maximum likelihood estimation (MLE). An MLE fitting routine can be used to find the best fit parameters for a given theoretical distribution.

Methods have been developed to fit data retrieved from a database to distributions where the data is collected at a non-zero threshold. The standard MLE likelihood function is the density function, but where loss data is truncated (not collected above or below a particular loss threshold), the likelihood function must be modified to describe the conditional likelihood; for example, the likelihood of loss in excess of the reporting threshold. For left truncated data, one can achieve this by taking the original density function and dividing it by the probability of loss above the threshold, as shown below:

$$P ( {x}_{1} , {x}_{2} , … , {x}_{n} \vert θ ) = \frac{{\prod }_{i = 1}^{n} p d f ( {x}_{i} \vert θ )}{[ 1 - c d {f ( T \vert θ ) ]}^{n}}$$

where θ is the parameter vector,
the xᵢ refer to the actual empirical data, and
T is the threshold value above which the data is collected.

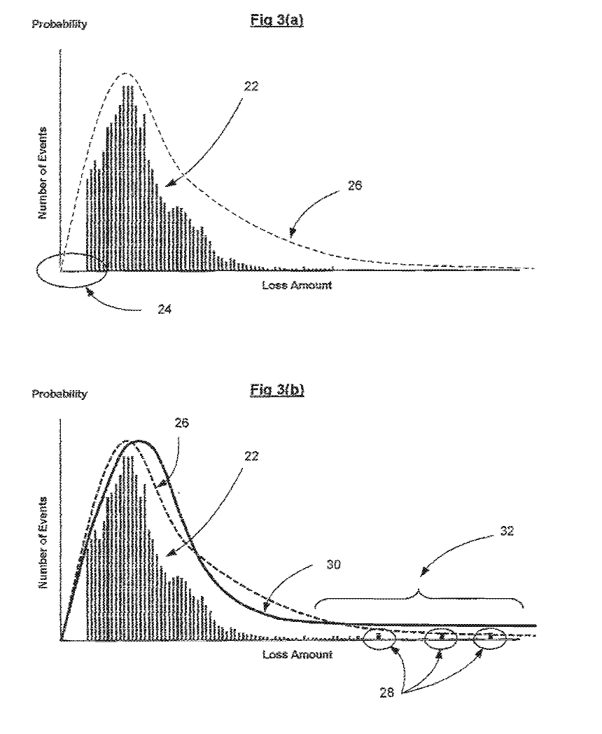

Using the method above, one can use modified MLE to fit truncated data. This process of fitting a theoretical distribution to truncated data is illustrated graphically in FIG. 3(a). A number of hard data points retrieved from a database are used to plot a histogram 22 of number of events against loss amount (missing data 24 is the data below the data collection threshold—the truncation point). The best fit parameters for a given severity distribution curve 26 is then determined using the modified MLE approach.

FIG. 3(b) illustrates such an attempt; where the original severity distribution 26 is manipulated by expert opinion with carefully chosen “relevant” data points obtained from “scenario analysis” or industry data 28 to generate a modified severity distribution curve 30. However, this process of combining data from one data set with cherry-picked data from another data set 28 to increase probability mass in the tail portion 32 of the distribution is not theoretically valid.

The illustration explains the process currently used to incorporate data or information obtained from other sources into the tail of the existing severity distribution. The starting point is the original severity distribution PDF 26 from FIG. 3(a) (dotted line). The second PDF 30 shown in FIG. 3(b) is the new theoretical distribution after inclusion of three “relevant” data points 28 that have been cherry-picked from industry sources. There is no theoretically valid or “right” way of combining individual data points from different sources. This is because each individual data point contains two pieces of information, the loss amount and the relative number of losses at this level in the context of its source. For example, three losses over $10,000,000 in a data set of 100 data points suggests that, conditional on an event taking place, the probability that the loss will exceed $10,000,000 is 3%. Once you remove an individual data point from its source data, it loses all informational value.

Therefore, the above mentioned process is by definition an arbitrary process. What happens is practice is that practitioners add or subtract data points until the resulting curve produces parameters that will result in expected and unexpected loss figures that are consistent with some predetermined outcome. In other words, practitioners directly manipulate the data until they get an answer that they think is the “right” answer. In case it is unclear why this is not an objective process, it should be mentioned that by adding or subtracting the right data points one can get virtually any model to produce virtually any result.

Because of the problems noted above, many people have been searching for a more intuitive method of estimating frequency and severity distributions. Some have suggested that since the Poisson distribution is effectively a one parameter distribution, all one needs to do is estimate the mean; which they suggest can be done by expert opinion. Additionally, it has been suggested that if one were to assume that severity would fit a lognormal distribution, one could also use expert opinion to derive the underlying parameters of this distribution. This could be done by first estimating two points on the curve, such as the median and the 90% quantile value. Because the lognormal is a two parameter distribution, one only needs two points on the curve to derive the parameters for the distribution (a lognormal distribution is a distribution where the log values of the data follow a normal (Gaussian) distribution, so the lognormal is also parameterized by mean and standard deviation).

This simplified method typically fails, because the process of estimating parameters for heavy-tailed distributions is not intuitive for many reasons. Firstly, estimating the 90% quantile value is not very easy, but as it turns out it is far easier to do this than it is to estimate, for example, the mean. This is because the mean is significantly affected by outliers, and it is very difficult to determine how much effect the tail has on the mean. For example, to estimate the mean number of people who are killed by ocean waves each year would require knowledge of, for example, the impact of the one in a hundred year tsunami; if this tsunami kills on average 500,000 people, then in discrete terms that event contributes 5,000 to the mean.

Secondly, to avoid the problem associated with estimating the mean, many practitioners have suggested using the mode (the most commonly occurring loss) instead. Unfortunately, few people have intuition about this input either. In fact, for heavy tailed distributions the mode is generally much, much smaller than most people realize, so the mode is perhaps even harder to estimate than the mean.

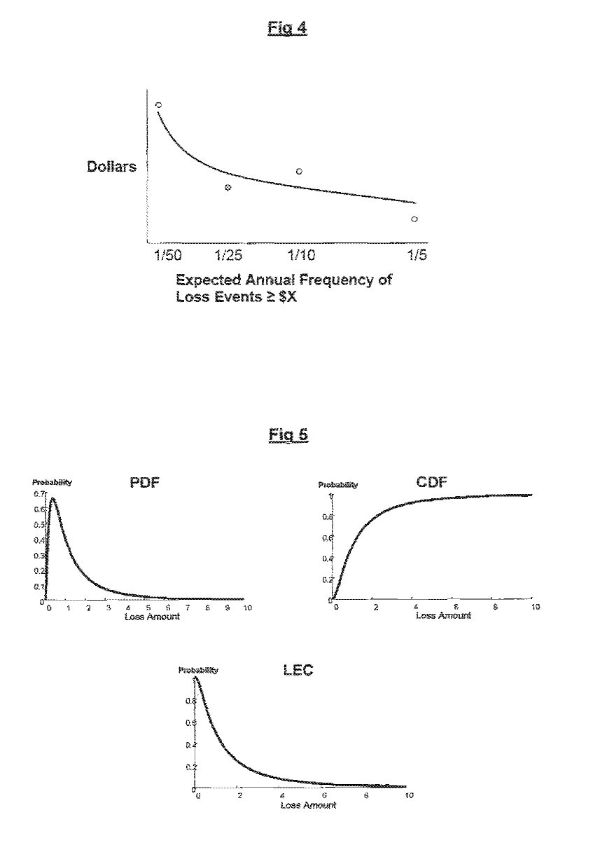

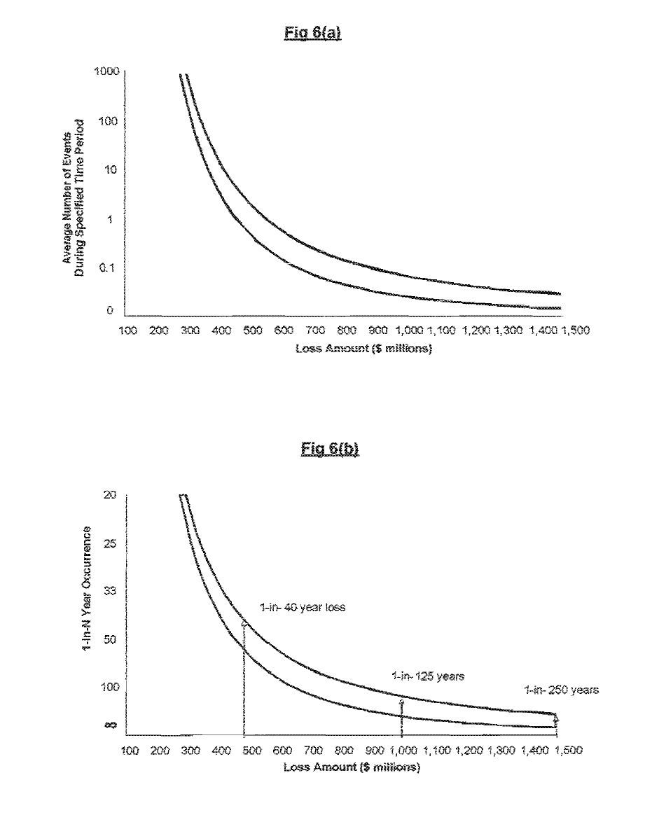

A more advanced solution to this problem was to express loss information in terms of expected annual frequency or in terms of 1-in-N years. FIG. 4 is a graphical example representing this approach. However, this method is also fundamentally flawed because practitioners who used this approach failed to recognize that the curve to which the data is fitted is not a loss exceedence curve (LEC) (a form of a severity distribution), but it is instead actually an “annualized LEC”, which includes both frequency and severity information. Stated differently, each annualized LEC (or “ALEC”) represents a severity distribution conditional on expected annual frequency; and without knowing this expected annual frequency (the mean of the frequency distribution) there are potentially a huge number of severity distributions that could fit the data. The only way one can derive the severity distribution from this information is by factoring out the impact of frequency; but in order to do this it is necessary to know the mean annual frequency at each loss threshold. Because in the past the problem was incorrectly specified, all previous attempts to solve this problem failed.

In order to solve this problem one has to fully understand certain fundamental concepts. First one needs to know that that severity can be represented as a PDF or a cumulative distribution function (CDF), which is the cumulative value of the PDF at any point. The CDF expresses, for any level of loss, the probability that a loss will be equal to or below that value. The complement of the CDF function (1−CDF) expresses the probability of a loss exceeding that value; these probability and loss combinations represent a continuum which is referred to as a loss exceedence curve (LEC). FIG. 5 shows these concepts graphically.

The PDF, CDF and LEC are pure severity distributions. They are independent of loss frequency in that they have no time element. A PDF, CDF and LEC will only provide probabilistic information on the relative magnitude of a loss, conditional on a loss occurring. They will not provide any information about the probability of a defined $X loss occurring in any time period.

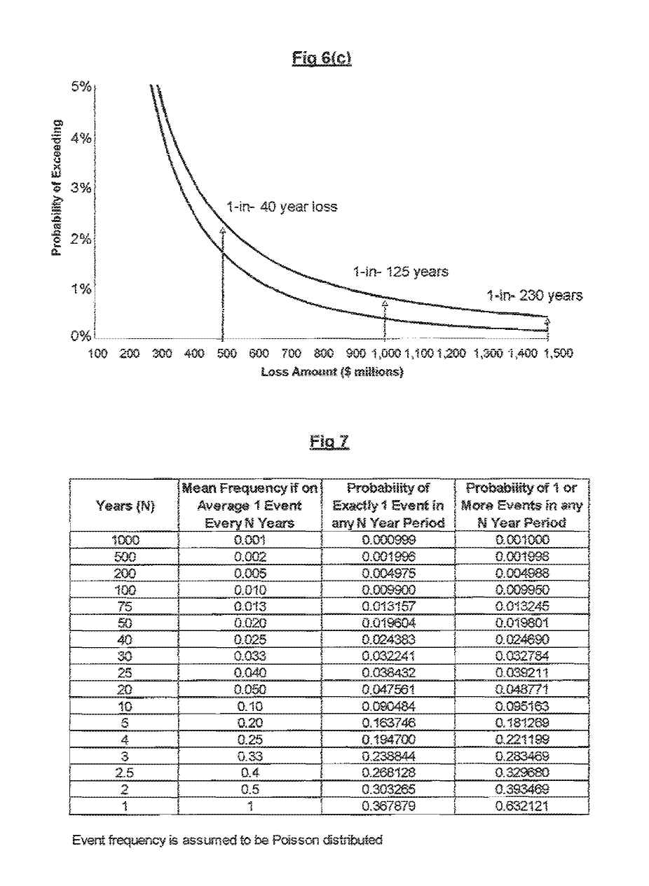

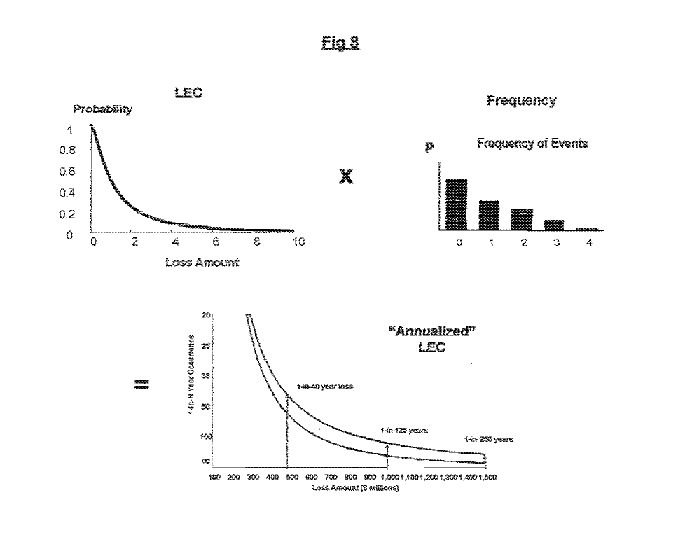

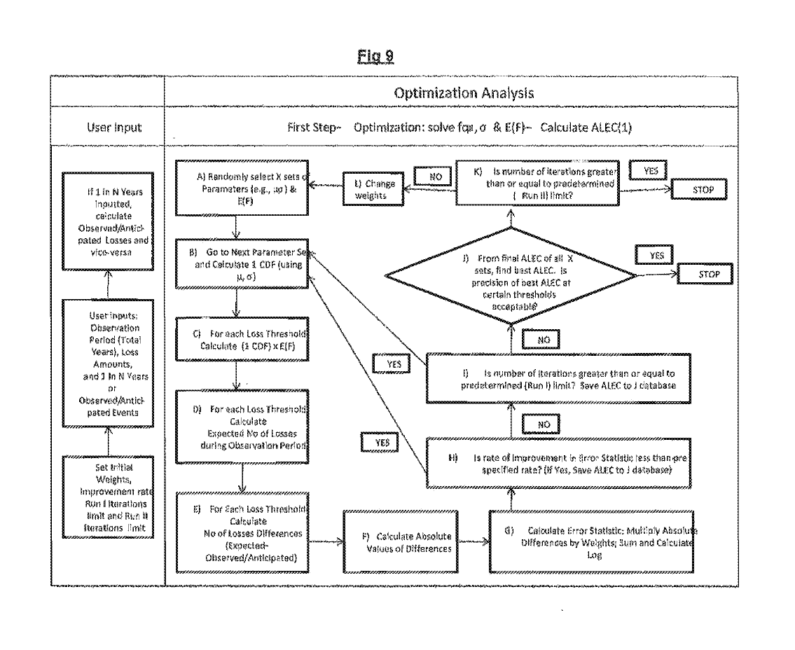

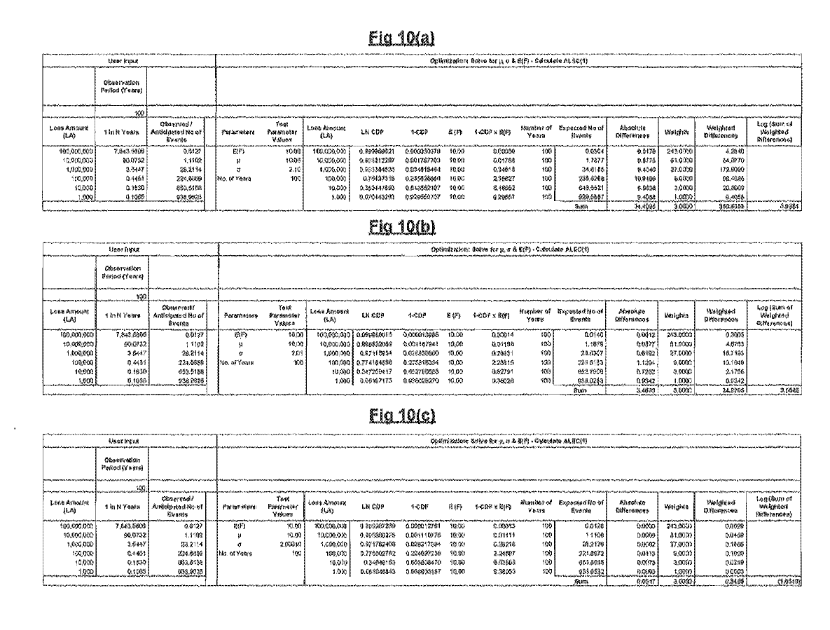

The new methodology of the present invention recognizes that an ALEC represents the LEC conditional on an expected frequency. An ALEC can be specified in many ways. Three correctly labeled and specified examples of an ALEC are shown in FIGS. 6(a)-(c). For the ALEC in FIG. 6(a) the Y-axis can be expressed in terms of event occurrences during the observation period or average number of events during the specified time period (an ALEC1A). In FIG. 6(b) the Y-axis is expressed in terms of Expected Event Frequency as 1-in-N Year Occurrences (an ALEC1B). One can convert event occurrences during the observation period to N years as follows: Total Years in Observation Period divided by Number of Event Occurrences during the Observation Period=N Years. In FIG. 6(c) the 1-in-N Years Occurrence (Y-axis) values are converted into probability (based on the assumption that event occurrence frequency is Poisson distributed). FIG. 7 is a table that shows the relationship between 1-in-N Year occurrences and probability, where event frequency is Poisson distributed.

In practice, historical loss severity data is retrieved from one or more data sources or obtained from expert option (using a computerized input module) and is used in a computerized optimization routine (using an optimization module) to derive the best fit severity distribution parameters and expected (average) annual frequency from the data. This information can then be used, where appropriate, to estimate expected loss, unexpected loss and other metrics to use in decision analysis.

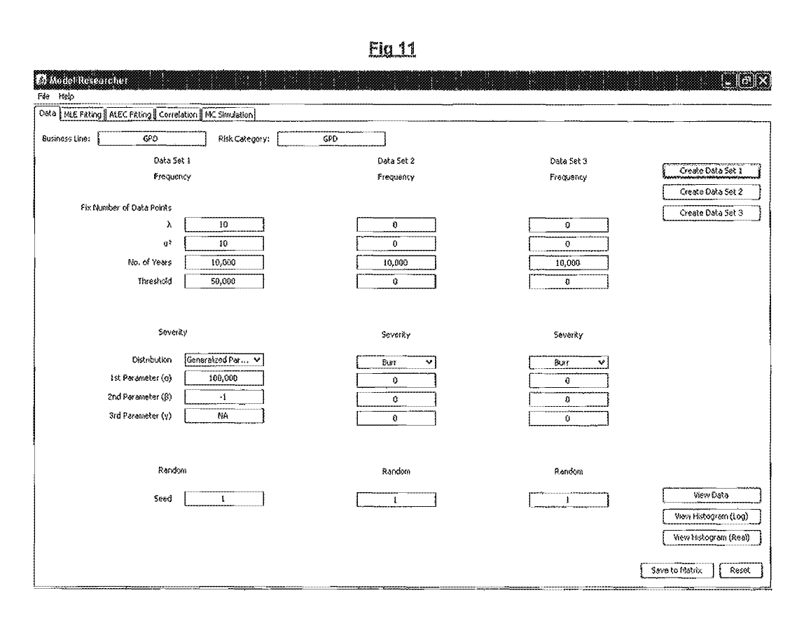

It will be appreciated that an ALEC represents a unique combination of one loss frequency and one severity distribution. FIG. 8 shows this concept graphically, and it should also be apparent that different annual loss frequency values will result in different ALEC values.

Given this function, it is possible to develop an optimization routine to derive the expected frequency and severity parameters simultaneously, by fitting the data obtained by the input module to a lognormal severity distribution conditional on an expected (average) frequency. This is undertaken by a computerized optimization module.

The optimization module routine employs a gradient search routine which may be obtained from a commercial software provider. The routine calculates a weighted error test statistic and the sum of the weighted error statistics are then transformed into logarithmic values. In order to handle large loss values, the routine scales all input thresholds by dividing each threshold by the smallest value and then rescaling the mean severity parameter. The routine can also handle N year events in fractions.

The following paragraphs explain the mathematical procedure for deriving the ALEC and the resulting risk metrics. Suppose, the expected loss exceedence for a given loss Li is denoted by T(Li). Therefore, the interest is in learning about the mean or expected frequency parameter (this will be relevant at a later stage because the expected (or average) frequency is the sole parameter which fully defines a Poisson distribution, i.e. λ).

The average number of events (expected frequency) is denoted by E(F). This measure is important because it is necessary to have an understanding of the cases when the average number of losses will take place. Since there is interest in Pr(L≧l), there is also interest in the quantity of (1−CDF), commonly known as the LEC (where Pr represents probability, L represents a random variable for the loss and l represents a realized loss). The philosophy of methodology of the present invention argues that the single event loss exceedence and any given threshold, T(Li), can be described as a convolution of the severity component and the frequency as follows:

(1−CDF)*E(F)=T(Lᵢ)

Now the assumption is made (from empirical evidence) that the loss frequency follows a Poisson distribution, and the severity follows a normal or lognormal distribution with parameters (mean (μ), and standard deviation (σ)). Therefore the final equation is the following:

(1−LogN(μ,σ))*λ=T(Lᵢ)

where LogN represents the Lognormal distribution.

Thus from the mathematical derivation above, the optimal choice of values (μ*, σ*, λ*) which will best fit the input data is needed. In risk management, as there is particular interest in the “tail” events, accurate modeling is required of the high severity, low frequency losses. Therefore, instead of using a least-squares approach with uniform weights (the current standard methodology), the method of the present invention uses an optimal weighted least-squares approach to solve for the best (μ*, σ*, λ*). The routine uses the concept of linear weighs; so, for example, if the user inputs the following data for the losses: 100,000; 200,000; 300,000; 750,000; 2,000,000, then a linear weighting scale would be: 1; 2; 3; 7.5; 20. Fractional weighting is also possible, where weights would be, for example, half of the linear weighting (so for the above example, the weights would be 0.5; 1; 1.5; 3.75; 10); however, a better weighting scheme tends to be based on a consistent linear increment, such as a factor of 3. This would result in weights as follows (1; 3; 9; 27; 81.) This weighting scheme places more emphasis on the higher loss region—the region most relevant for risk management.

This routine also employs a new statistical test statistic for measuring the goodness of fit. Because it is important to exaggerate the test error—in order for the routine to continue searching for a good fit—the routine can calculate the log value of the errors. However, this has certain practical problems, because a very small error results in a divide by zero error, which would cause the routing to terminate prematurely. So instead the routine calculates the log of the sum of the absolute deviations at all thresholds. This is also less computationally intensive than adding a small number to each individual error and then taking the log. This quantity is then minimized through optimization.

Then the routine uses a Monte Carlo based approach to find the optimal values for (μ*, σ*, λ*). This process begins by choosing an initial random value set of (μ₁, σ₁, λ₁) . . . (μₙ, σₙ, λₙ). These values are referred to as the starting values. To obtain these values, the routine obtains a random sample from a uniform distribution within a range of: 1≦μ≦20, though other ranges could be used. For the standard deviation parameter, the initial range is typically 0.01≦σ≦15, though other ranges could be used. Finally for the frequency parameter (λ), initial starting range is set as follows:

λᵢₙᵢₜᵢₐₗ≦λ≦100*λᵢₙᵢₜᵢₐₗ

Here, the initial frequency parameter (λᵢₙᵢₜᵢₐₗ), is obtained from the user input data. The λᵢₙᵢₜᵢₐₗ value is calculated by taking the minimum 1 in N year input and inverting the value. (All above values and/or ranges can be specified manually by the user.) With this set of initial values, the routine randomly generates a number of trial values A (or X sets in FIG. 9). The routine then applies a global minimization search routine (using a standard commercial software package), which produces an initial set of results. The routine saves the results from each of the starting (μᵢ, σᵢ, λᵢ)→(μ̂, σ̂, λ̂). At the end of the first run, the routine produces A sets of values for (μ̂, σ̂, λ̂).

In order to increase the certainty of truly finding the global minimum, the routine repeats this process up to B run times (based on user preferences) or until the test-statistic (the log of the sum of absolute deviations) improves by less than a predetermined rate (C %) (based on user preferences). The search routine has three pre-specified precision levels, which are expressed as High, Medium and Low. Each of the levels represents a combination of tolerance criteria, such as error limits, number of iterations, number of initial value sets. This method increases the likelihood of finding a global (not local) minimum. In addition, the routine has been designed such that if the final output does not produce a fit within a predetermined precision requirement error limit (e.g., 10%), the routine will increase the weights by 1 and start over. Thus if the first run began with weight increments of 3 (1, 3, 9, 27, 81) the second run would include weights of (1, 4, 16, 64, 256). Finally, to make practical sense, we choose the optimal (μ*, σ*, λ*) from our final list such that μ*>0. All these abovementioned features are necessary only where the actual severity data are not lognormally distributed or normally distributed in the case of Market risk data.

All above mentioned initial range values are available as user inputs, but these pre-specified values appear to provide precise, stable results across the reasonable range of loss data.

FIG. 9 shows a flow chart of the main features of a preferred embodiment of the optimization routine. The routine starts with the initial value sets for the distribution and derives ALECs; and corresponding weighted error test statistics compared with the input information collected in the input module. Based on the error test statistics, and/or the number of allowable runs, improved ALECs are created, and an overall best fit ALEC is chosen by virtue of it having the lowest error test statistic. If the overall best fit ALEC conforms with a predetermined precision requirement then that ALEC is considered the estimation ALEC from which risk of loss is determined. In FIG. 9 an ALEC1 is represented, but it will be appreciated that an ALEC2 can easily be derived from the ALEC1.

FIGS. 10(a)-(c) shows the results of a simple optimization routine. Value sets for the parameters are shown with only standard deviation being varied (from 2.1 to 2.01 to 2.0001). It can be seen that the differences between the observed and expected number of events at each loss threshold improves as the parameter value sets are honed; and the results are especially accurate at the high loss amount tail portion almost from the initial value set. In the results, the generic ALEC1A has been created, expressed in terms of E(F) and 1−CDF (this can easily be converted to ALECs having Y-axis values expressed as 1-in-N years (ALEC1B) or probability (ALEC2).

Fitting data to an ALEC can sometimes be accomplished with only two inputs, but this will generally not result in a unique solution or a stable risk profile. The ALEC curve has three degrees of freedom: two for severity (mean and standard deviation) and one for expected frequency (mean). Therefore, three inputs are required to derive a unique ALEC. As it is possible to estimate frequency at any non-zero threshold and, given a severity function, the implied frequency at the zero threshold can subsequently be estimated—based on the relative probably mass.

Nevertheless, fitting an ALEC is not a trivial matter. Because real world losses are not likely to be perfectly representative of Poisson loss frequency and lognormal severity distribution, there are many other theoretical and practical problems to be addressed in order to make this approach workable. This is achieved through optimization and features of this optimization routine are outlined below.

It should be apparent that the methodology of the present invention can be used to fit the tail of a distribution directly; for example, it can be used to fit the tsunami-driven wave portion and ignore the wind-driven waves. This provides a representation with improved accuracy of the part of the distribution that is most relevant for risk analysis at the high loss tail portion. After all, only the tsunami waves represent the one in a hundred year type events. Because the method involves the fitting of points to a curve, this method does not suffer from the same constraints as MLE, which gives much more emphasis to the body (the small loss region) of the distribution and not the tail.

One other very important feature of this approach is that it can be used with either hard data, or soft data, or even with a combination of soft and hard data. Combining hard data and soft data legitimately has been a challenge that analysts have been struggling with from the early days of mathematical modeling. This is because most models fit raw data directly to distributions. Each data point carries two pieces of information, the loss value and its relative probability in its original data set. By removing a loss data point from its original data set it loses half the information and is rendered to be of no value. Adding data points directly, artificially, changes probability mass and consequently has no theoretical validity.

The method of the present invention addresses these problems. Hard data can be used for the small loss regions, in order to fit a set of baseline frequency and severity distributions which can then be transformed into a baseline ALEC. Since the points on this curve are expressed in terms of 1-in-N year events, one can incorporate soft data by specifically modifying only those 1-in-N year events that need to be changed. Provided the soft data are legitimate data, there is nothing theoretically invalid about this process.

One other benefit of this specific approach is that it is very effective even when the underlying data is not “generated” from a lognormal severity and Poisson frequency distribution. This is a major advantage over even MLE based methods, and fitting a lognormal severity distribution to a truncated heavily tailed severity distribution will typically cause the fitting routine to “crash”, or produce unreasonable parameters, such as a negative μ.

MLE has three important drawbacks when compared with the present invention, namely:
1. MLE requires large amounts of data, because one requires many data points to estimate relative probability mass at each loss level to calculate the best fit distribution function.
2. MLE requires that the type of distribution function be pre-specified. MLE will only produce the best fit parameters for a given distribution. One has to fit data to several distribution functions and then use a different set of “goodness of fit” tests to determine which distribution is the overall best fit.
3. MLE places more emphasis on the fit in the body, instead of the tail, because there are more data in the body.

Because the methodologies of the present invention, in its base case, allows for each input point to be fitted to the ALEC with equal weights, it gives much more relative weight to the fit in the tail. In addition, because of the incremental weighting scheme employed by this routine, the program results in a much more precise fit in the tail. Furthermore, because the routine simultaneously fits both frequency and severity parameters, it fits using at least three degrees of freedom, which gives it much more flexibility. These features provide a significant advantage over MLE, because they allow the methodology to be much less distribution dependent. To test this one could generate data from an extreme value distribution (such as a Generalized Pareto Distribution, GPD) and determine how well the total results compare to one another.

An example of this is provided in FIGS. 11 to 15. In this example, data is generated from a GPD (100,000, −1) and fit to several distributions using MLE as well as to an ALEC. A model should produce good results regardless of the data set; in FIG. 11 it can be seen that additional data sets can be created and combined with other data sets (for example, a wind-driven data set can be combined with a tsunamis-driven data set to model all waves).

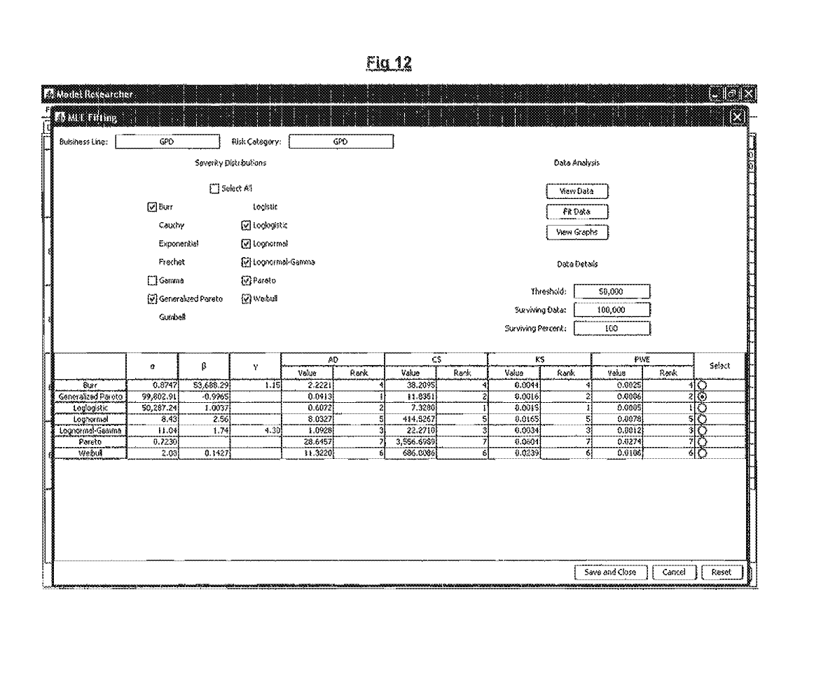

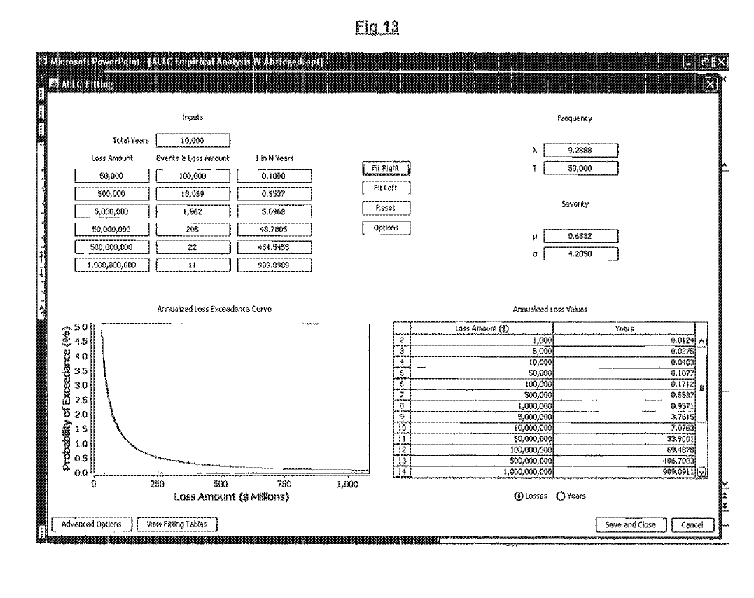

FIG. 12 shows that three out of four statistical tests (CS, KS and PWE) show the loglogistic distribution to be the best fit through MLE of the various distributions applied. Only Anderson Darling (AD), which gives weigh to the tail portion, shows GPD as the best fit. FIG. 13 shows the results of an ALEC method of the present invention; where it fits “normalized data” expressed as 1-in-N loss exceedences providing a good fit generally, but providing a particularly good fit at the tail portion (see higher loss amounts in the inputs and modeled values, such as the one billion dollar level).

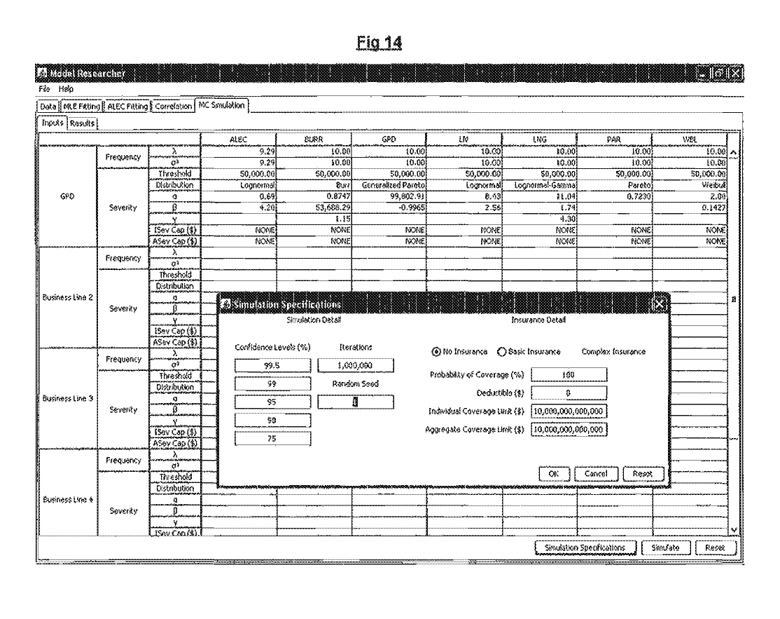

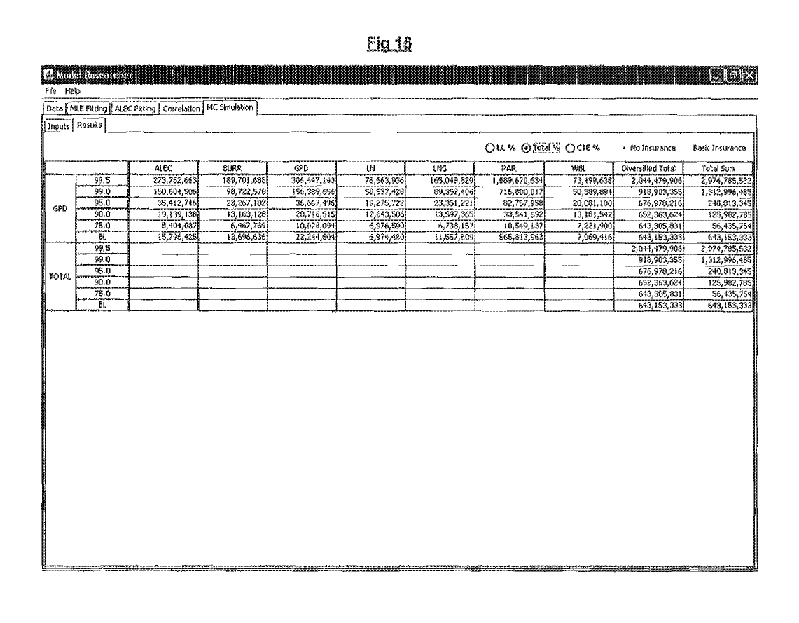

FIG. 14 shows a Monte Carlo simulation conducted at one million iterations (see the inputs of the simulation specifications, and note that the lambda frequency value is itself derived), revealing (in FIG. 15) that ALEC methodologies of the present invention produce total exposure results much closer to the GPD (the control) at any confidence level than any other distribution fitted using MLE.

### EXAMPLES

### General Example

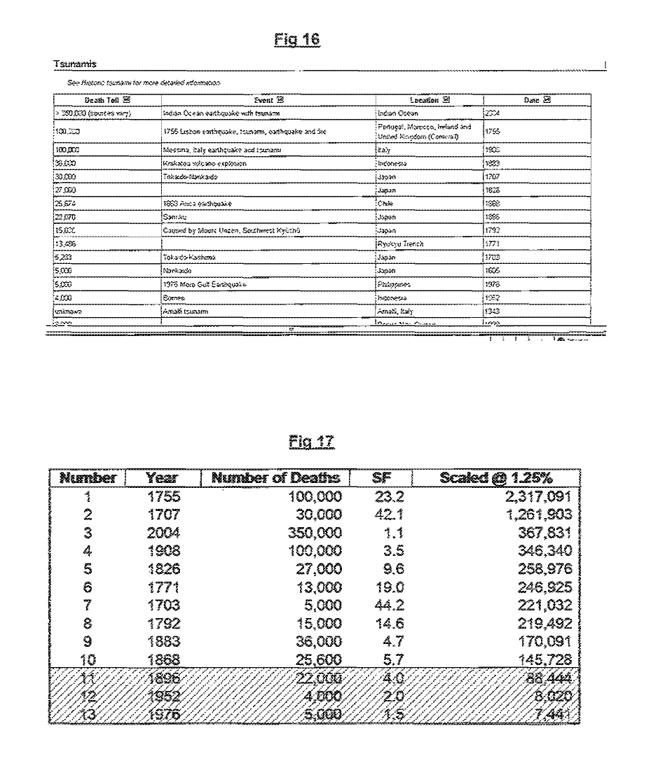

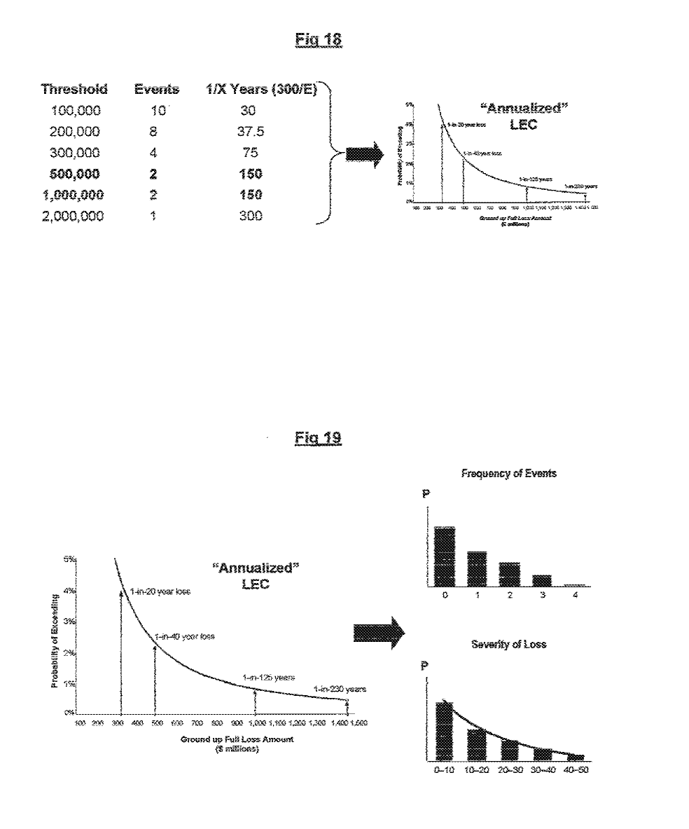

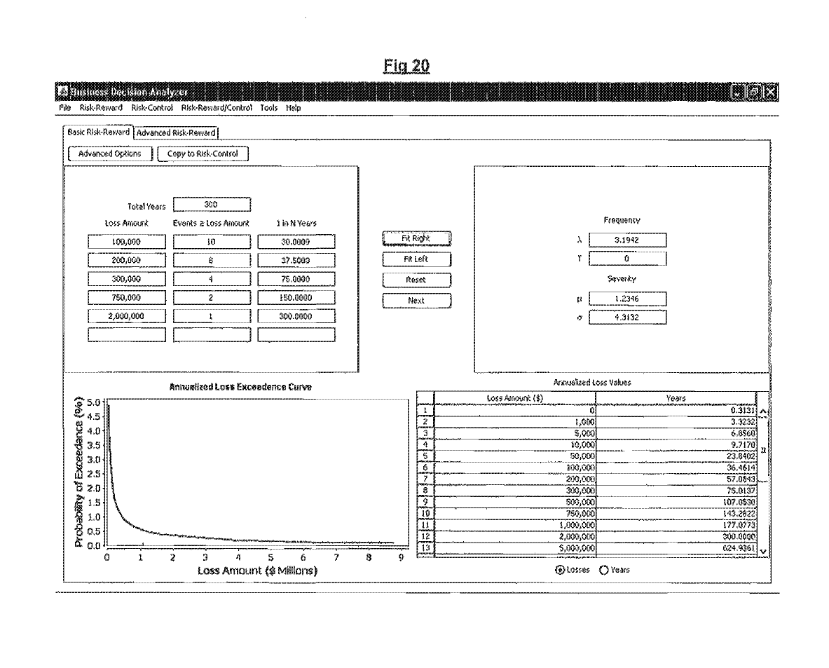

A working example will now be described, for estimating Tsunami risk, in order to demonstrate how the methodology of the present invention might be applied in practice.
1. From the open-source Wikipedia website, it is possible to determine the number of tsunamis that have taken place in the past several hundred years and their associated magnitudes (measured in human lives lost). This information is shown in FIG. 16.
2. The data retrieved from this database is then normalized by scaling for population size (then and now) based on an estimated 1.25% annual population growth rate. The data is then “cleaned” to eliminate all the tsunamis below a threshold of 100,000 deaths (as smaller events are more likely to be unreported and so many of these events may not have been captured). This leaves 10 events for consideration, as shown in FIG. 17.
3. The relevant normalized raw data is then converted into loss events per 1/X years, by counting how many events at each threshold have taken place in the past 300 years. This step would be undertaken in an input module. FIG. 18, shows the converted loss events per 1/X years fitted to a single event ALEC, which can be modified or supplemented with expert opinion. For example, 10 tsunamis at the 100,000 threshold in a three hundred year period translates to one tsunami occurring every 30 years. Put differently, 0.0333 events per year can be expected at the 100,000 threshold; a step performed by a computerized loss determination module.
4. The data is then fitted to the software optimization routine (in a computerized optimization module).
5. Finally, except in the case of market risk, means for undertaking Monte Carlo simulation are applied to estimate the aggregated Expected Loss, the aggregated Unexpected Loss (at a high confidence level, such as the 99% level) and aggregated Cost of Risk; to determine the cost to society (for example, whether we should invest in tsunami warning systems). Put differently, the Monte Carlo simulation provides the aggregate distribution for combined worst case frequency and severity distribution for a specified time horizon, thereby providing the aggregate exposure for a particular time horizon. Other assumptions can be varied and applied in the simulation as well, such as whether insurance was taken, increasing the value of the business decision metrics obtained.

FIGS. 20 and 21 show screenshots of a computer program implementing the methodology of the present invention as applied to the above wave example. It can be seen that a mean frequency (3.1942) and severity parameters of mean (1.2346) and standard deviation (4.3132) are derived, which after application of the Monte Carlo simulation produces an estimation of the aggregate expected loss (40,333) and unexpected loss (1,185,515) at a 99% confidence.

### Operational Risk Example

Another simple example of the application of the present invention, in respect of operational risk economic capital follows. Suppose 315 hard and/or soft data points were observed and collected in respect of 300 company years (60 firms, each monitored for 5 years). The number of observations at each loss threshold could then be counted and the data fitted to an ALEC, to provide input and fitted output results as shown below.

| | | 1-in-N years | 1-in-N years |
|---|---|---|---|
| Loss Threshold | Observations | Input | Output |
| $1,000,000 | 315 | 0.9524 | 0.9524 |
| $5,000,000 | 96 | 3.1250 | 3.0272 |
| $25,000,000 | 19 | 15.7895 | 15.7895 |
| $50,000,000 | 8 | 37.5000 | 37.7968 |
| $100,000,000 | 3 | 100.0000 | 100.0000 |

The resulting fitted severity distribution (lognormal) has a mean of 12.6026 and a standard deviation of 2.0888. The estimated aggregate expected loss (9,868,771) and unexpected loss (98,868,387) at a 99% confidence (shown in the screenshots of FIGS. 22 and 23).

### Business Decision Analysis Examples

A third example can be applied to business decision analysis, specifically risk-reward analysis. Suppose there is a business proposition relating to a new $30 million seafood processing plant that is to be built near a river, which historical records suggest has a large flood once every 30-35 years. There are two options that can be considered, namely: (a) assume the flood risk and build the plant on the riverbank (estimated annual profit is $5 million); or (b) mitigate the flood risk and build the plant on a nearby hill and incur additional annual operating costs of $2 million (estimated annual profit is $3 million). What is the optimal solution; what is the risk-adjusted profitability of the riverbank option, and which option maximizes the risk-adjusted profitability at the risk tolerance of the stakeholders (at 99%)?

It is established that three large floods have taken place during the past 100 years (this is soft data). One was a major flood, the second was a moderate flood and the third was a slightly less severe flood than the second one. It is determined that if the plant were built on the riverbank, the following outcomes would potentially be applicable: (a) a major flood would completely destroy the plant and cause $30 million in damages, putting the plant out of business for 6 months; (b) a moderate flood would cause $10 million in damages and put the plant out of business for 3 months; and (c) a smaller, moderate flood would cause $5 million in damages and put the plant out of business for 1 month.

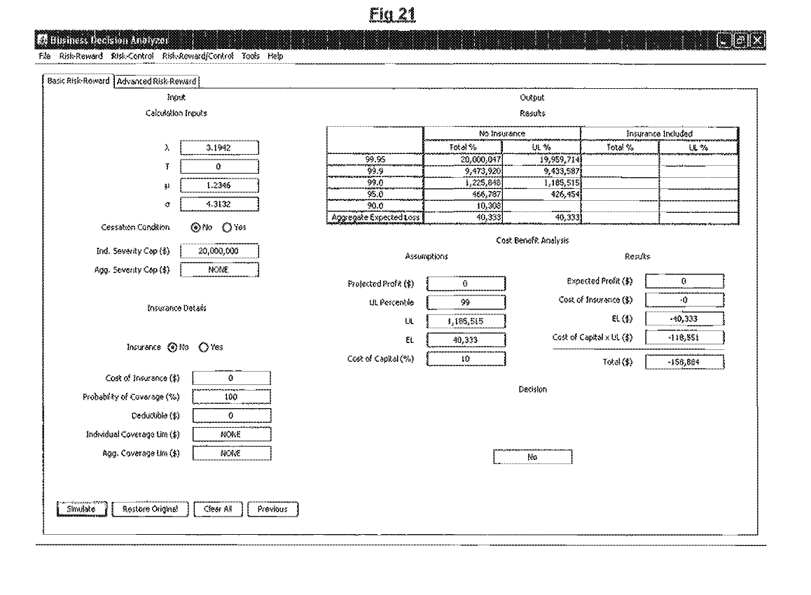

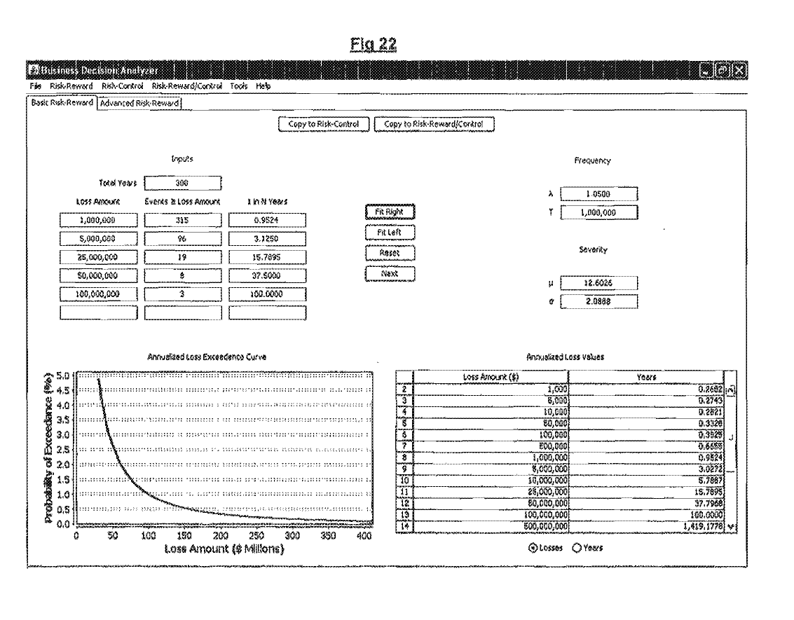

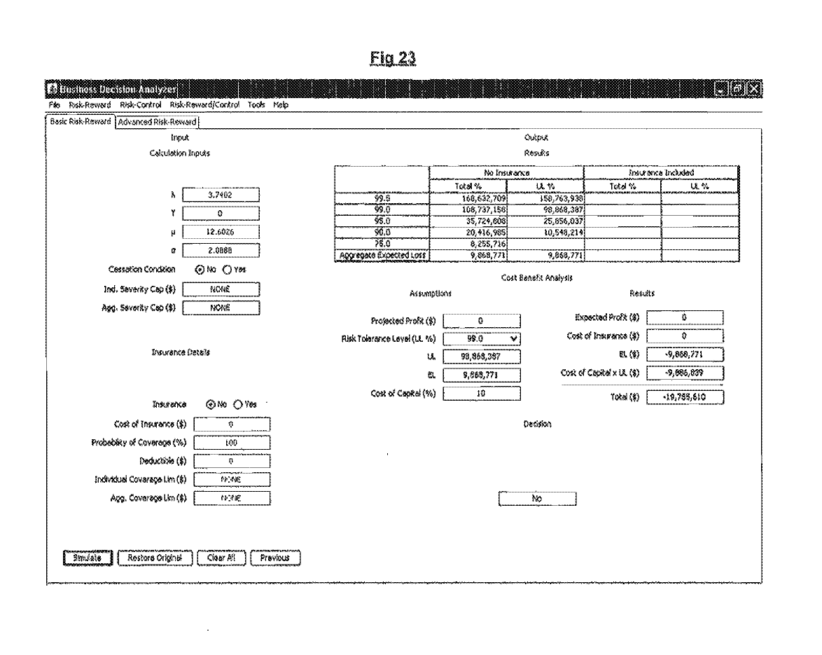

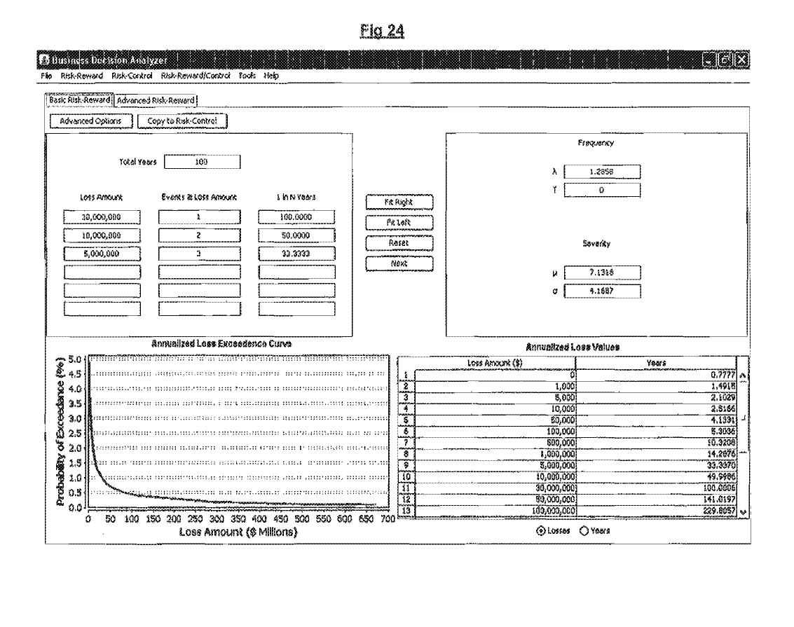

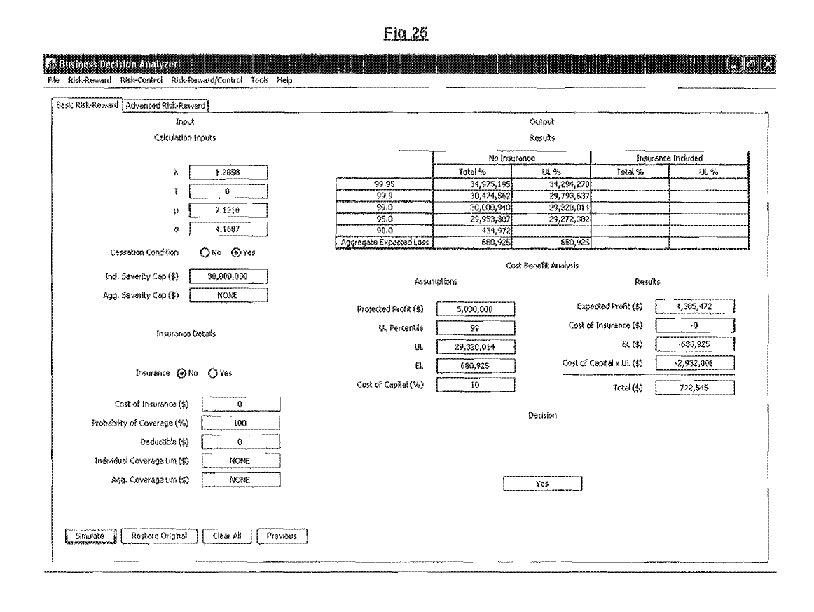

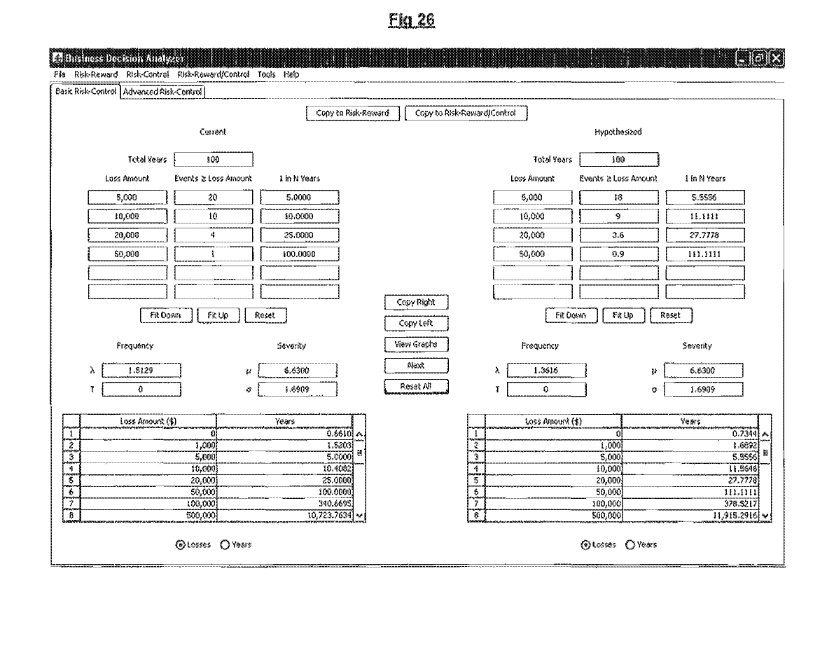

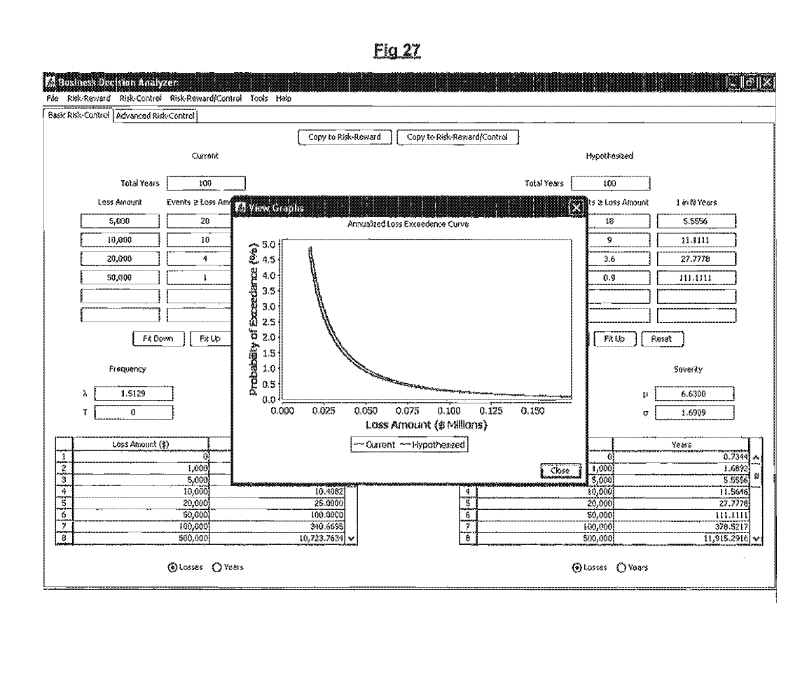

The methodology of the present invention would provide, for a plant built on the riverbank, a mean frequency (1.2858) and severity parameters of mean (7.1318) and standard deviation (4.1687), and an estimation of the aggregate expected loss (680,925) and unexpected loss (29,320,214) at a 99% confidence (shown in the screenshots of FIGS. 24 and 25). From this, the cost of risk (Expected Loss+(Cost of Capital*Unexpected Loss)) is $3,612,926. If one assumes other costs of the interruption impact amount to $614,528, the expected profit would have been $4,385,472 and the risk-adjusted profit would have been $772,546 (namely, 4,385,472−3,612,926). The result reveals that, although building a plant on the riverbank is appealing from an accounting perspective ($5 million vs. $3 million, it is clearly sub-optimal on a risk-adjusted basis ($0.77 million vs. $3 million).

By performing an independent calculation of risk-adjusted profitability (through a transparent process) one can determine whether the goals of business line managers are aligned with those of stakeholders. Moreover, managers, senior managers and executives are afforded access to the assumptions and data utilized in the risk estimation; enabling incorporation or verification of data applicable to rare “black swan” events if appropriate into risk measures and risk-based profitability metrics. This allows inclusion of soft data and expert opinion into risk models in an objective, transparent and theoretically valid manner; thereby updating the risk profile when historical data becomes obsolete.

With a structured and transparent process, corporate risk culture will reflect and harmonize the goals of key decision makers and external stakeholders in the business decision-making process, at both a tactical and strategic level. Information asymmetries between managers and stakeholders will be reduced as it will be evident if managers are not pursuing strategies that conform to the risk tolerance standards of the stakeholders; thereby mitigating principal-agent risk.

A fourth example, also relating to business decision analysis, involves risk-control and risk-transfer optimization. This example also demonstrates how the present invention facilitates decision analysis by allowing one to examine the feasibility of a business proposition under different assumptions and scenarios—in other words conduct risk sensitivity analysis.

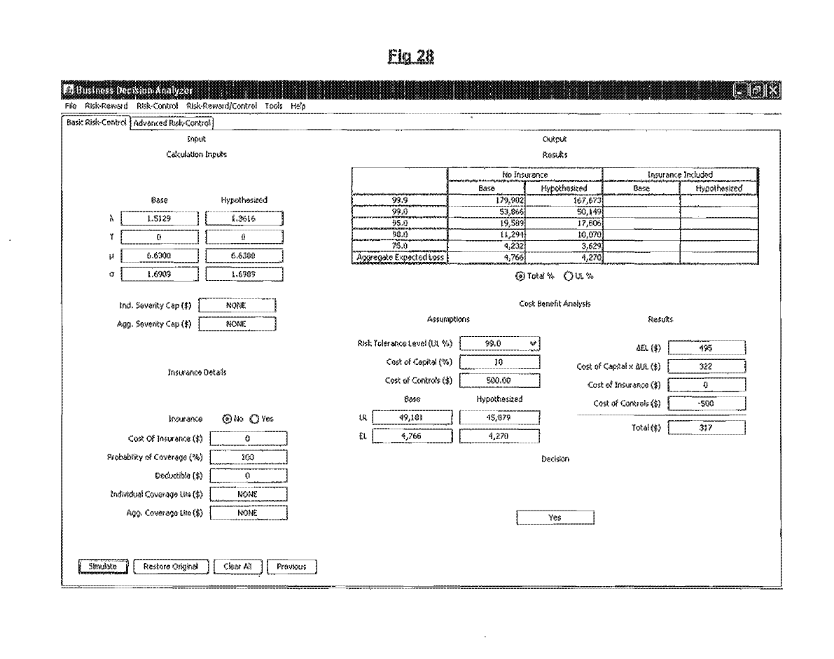

Suppose that a person has a car and wants to determine whether it is feasible—on a risk adjusted basis—to invest in new brake pads each year and/or to purchase insurance. This example is laid out in FIG. 26. Suppose the initial risk assessment is as follows: $5,000=1-in-5 Years, $10,000=1-in-10 Years, $20,000=1-in-25 Years and $50,000=1-in-100 Years. This means that in a 100 year observation period the number of anticipated events would be 20, 10, 4 and 1 respectively. Further suppose that maintaining the brake pads would cost $500 per year and it is hypothesized that this would reduce the number of events at each loss threshold by 10%. This would mean the in a 100 year observation period, the anticipated number of events at the same thresholds would be 18, 9, 3.6 and 0.9 respectively. Fitting both sets of inputs using the ALEC methodology of the present invention results in current and hypothesized ALECs, with the following parameters:

| Parameters | Current | Hypothesized |
|---|---|---|
| E(F) or λ | 1.5129 | 1.3616 |
| μ | 6.6300 | 6.6300 |
| σ | 1.6909 | 1.6909 |

By viewing the graphs in FIG. 27, one can see the hypothesized ALEC superimposed over the current ALEC, which shows see how these two curves relate to one another.

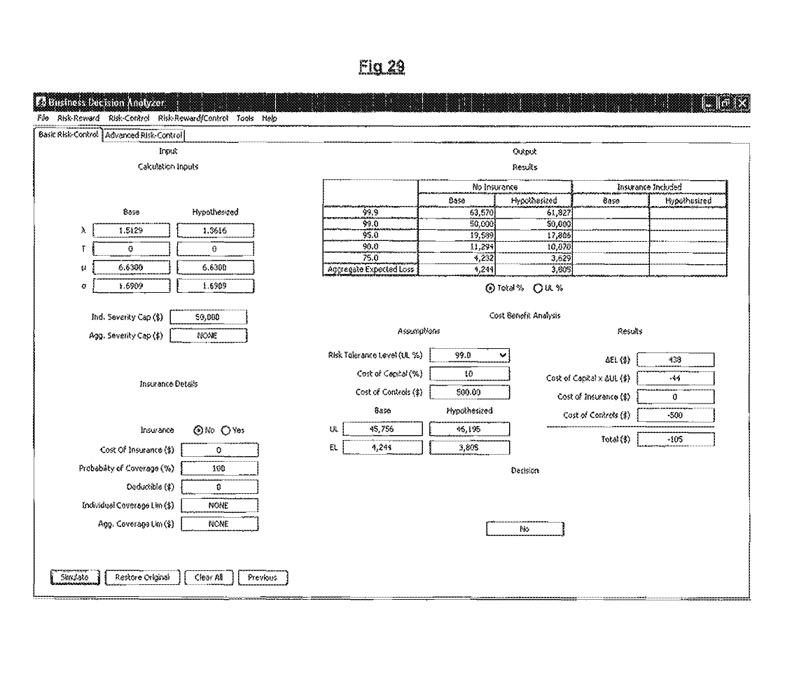

The next step is to conduct side-by-side Monte Carlo simulation analysis and to calculate the change in the cost of risk. Suppose the risk tolerance standard of this stakeholder is 99% and the cost of capital is 10%. As shown in FIG. 28 an embodiment of the present invention allows one to determine whether this is a feasible proposition. Here the example shows that the reduction in expected loss is $495 (a benefit) and the reduction in cost of capital multiplied by the change in unexpected loss at the 99% level is $322 (a benefit). Given the annual cost of controls is $500 (a cost), the next result (benefits−costs) is a benefit of $317. Because this value, the net benefit, is positive the applied methodologies of the present invention shows that this proposition makes sense (Decision=Yes). In other words, by conducting risk-based, cost-benefit analysis at the risk tolerance standard of the stakeholder, given the prevailing cost of capital, one can see that this is a feasible proposition.

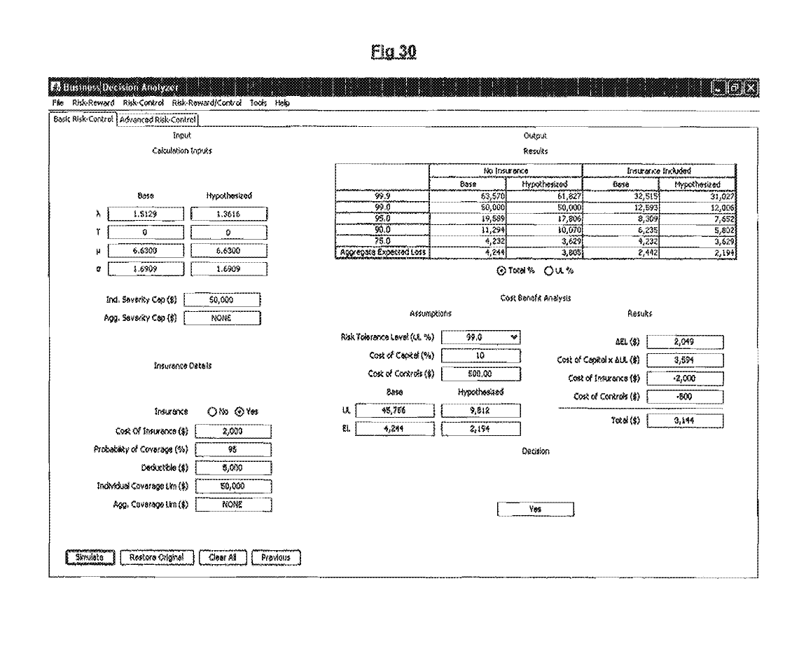

In addition, the present invention allows one to conduct further risk-based sensitivity analysis. Suppose, for example, the maximum loss (the value of the car) is $50,000. By placing an individual upper limit on the loss severity distribution one can reassess the situation by conducting a fresh Monte Carlo simulation. This example is shown in FIG. 29. Under this scenario the net result is −$105, so the proposition is not feasible (Decision=No).

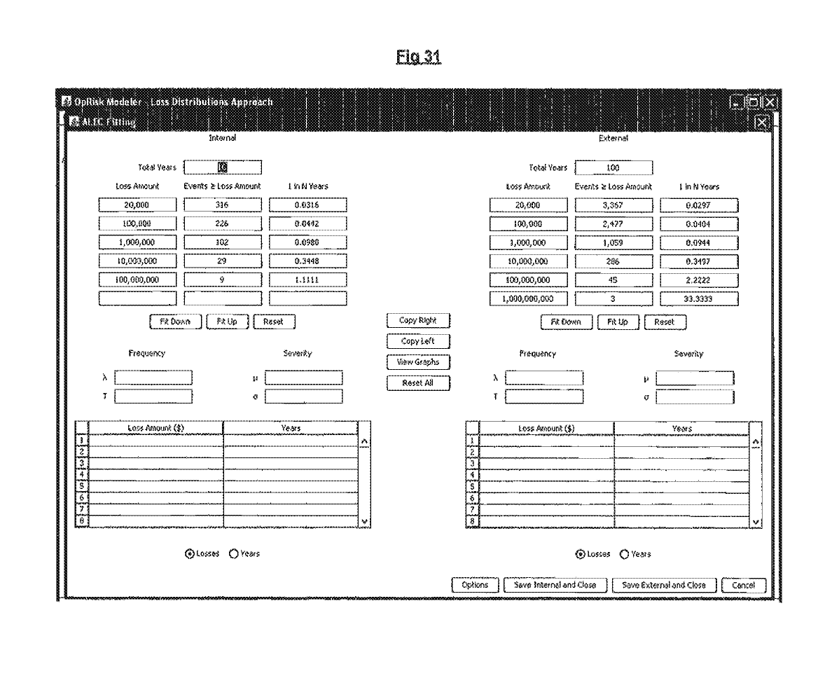

Lastly, the present invention allows one to conduct risk-based sensitivity analysis using insurance scenarios (risk-transfer analysis). This example is shown in FIG. 30. Here one also decides to purchase insurance, at an annual cost of $2,000, with a deductible of $5,000 and an individual coverage limit of $50,000. One also assumes that only 95% of the claims will be paid. Under this scenario, the net result is a gain of $3,144, so the proposition is feasible (Decision=Yes).

### Example of Mixing of Loss Data from Two Different Sources

A fifth example of the present invention involves mixing of loss data from two different sources. Recall that each individual loss data point contains two pieces of information, the loss magnitude and the relative probability of the loss at that threshold, which is measured by calculating the proportion of losses at that threshold in the source database. And once an individual loss is removed from its source data set it loses all informational value.

The present invention, however, allows one to combine normalized information from two data sources in the following manner. Suppose that one has two sources of information. Ten years of loss data from internal sources and a database of external industry data drawn from ten firms over 10 years. Assuming these firms all have similar risk profiles and the data are i.i.d., this is the equivalent of 100 years of company data. In this case, the present invention can help overcome the problem of insufficient data in the tail or large loss region.

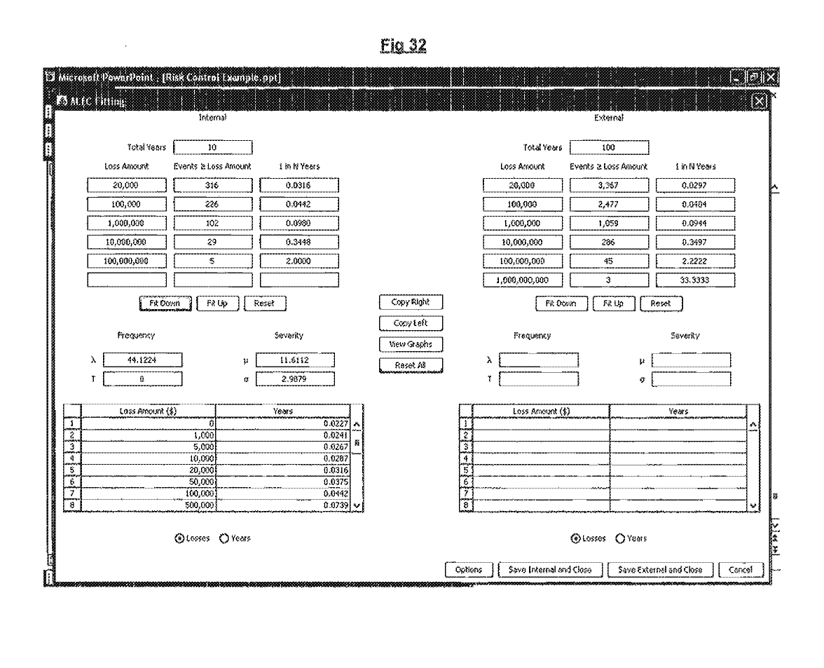

This example is shown in FIG. 31. Suppose that when analyzed at certain thresholds the internal and external data have the following properties:

| Internal | External |
|---|---|
| Number of Years | |
| 10 | 10 |

| Threshold | Obs | 1-in-N Yrs | Obs | 1-in-N Yrs |
|---|---|---|---|---|
| 20,000 | 316 | .0316 | 3367 | .0297 |
| 100,000 | 226 | .0442 | 2477 | .0404 |
| 1,000,000 | 102 | .0980 | 1059 | .0944 |
| 10,000,000 | 29 | .3488 | 286 | .3497 |
| 100,000,000 | 9 | 1.1111 | 45 | 2.2222 |

As one can see the present invention makes it possible for one to recognize that the internal and the external data have very similar properties. In fact, for all loss thresholds except the 100,000,000 threshold the 1-in-N year values are virtually identical. (The 1-in-N year value is a normalized representation of the loss potential.) If one assumes that the reason the 1-in-N information at the 100,000,000 threshold for internal data does not contain precise information at that threshold, because ten years of data is not enough time to experience a stable 1-in-N year estimate, one could replace the internal 1-in-N value with one based on the external 1-in-N year value.

This is demonstrated in FIG. 32. In this example the 1-in-N year value for internal data has been changed from 1.1111 to 2, which is approximately the 1-in-N year value from external data. And following this change the ALEC parameters are estimated—for later use in Monte Carlo simulation.

### Market Risk Example

This method of assessing/measuring risk can also be applied to Market risk. For example, in order to express loss information in annual terms (instead of daily price changes), one may express the loss thresholds as percent of change in daily prices. The number of events corresponds to the number of days in the observation period where such a decline was observed. Because in market risk, prices changes can vary from negative 100% to positive infinity, the underlying severity distribution must be somewhat symmetrical about 0. One example is the normal distribution.

In this case the λ value would refer to the observed/anticipated events which had a negative daily price change. Using this invention, one can calculate an N % risk on an annualized basis even where the data are expressed in terms of daily price changes. Furthermore, one can modify the 1-in-N year values for the larger percent declines using soft data—from gathered over multiple economic cycles (as shown in the previous example). One can also modify such inputs using expert opinion.

In summary, the present invention allows one to create or update the risk profile using hard data, soft data and/or expert opinion, or any combination of the three, in an objective, transparent and theoretically valid manner. It also allows one to conduct risk-based decision analysis and risk sensitivity analysis.

### Additional General Statements

Reference is made in this specification to the application of computers, computer implemented systems and computerized modules, that may be used in accordance with the method and system of the present invention and as applied in some example embodiments. It should be appreciated that a set of instructions may be executed, for causing such machines, systems and/or modules to perform any one or more of the methodologies discussed above. The machine may operate as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while a single machine may be described, a single machine shall also be taken to include any collection of machines that individually or jointly execute a set (or multiple sets) of instructions to perform any one or more of the methodologies or functions described in this specification.

Machine-readable media may be provided, on which is stored one or more sets of instructions (e.g., software, firmware, or a combination thereof) embodying any one or more of the methodologies or functions described in this specification. The instructions may also reside, completely or at least partially, within the main memory, the static memory, and/or within the processor during execution thereof by the computer system. The instructions may further be transmitted or received over a network via the network interface device.

In example embodiments, a computer system (e.g., a standalone, client or server computer system) configured by an application may constitute a “module” that is configured and operates to perform certain operations. In other embodiments, the “module” may be implemented mechanically or electronically; so a module may comprise dedicated circuitry or logic that is permanently configured (e.g., within a special-purpose processor) to perform certain operations. A module may also comprise programmable logic or circuitry (e.g., as encompassed within a general-purpose processor or other programmable processor) that is temporarily configured by software to perform certain operations. It will be appreciated that the decision to implement a module mechanically, in the dedicated and permanently configured circuitry, or in temporarily configured circuitry (e.g. configured by software) may be driven by cost and time considerations. Accordingly, the term “module” should be understood to encompass a tangible entity, be that an entity that is physically constructed, permanently configured (e.g., hardwired) or temporarily configured (e.g., programmed) to operate in a certain manner and/or to perform certain operations described herein.

The term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies or functions in the present description. The term “machine-readable medium” shall accordingly be taken to include, but not be limited to, solid-state memories, and optical and magnetic media.

1. A computer implemented system for estimating the risk of loss for a specified time period, the system comprising:
an input module, operable manually to retrieve and/or receive input information relating to a plurality of observed and/or anticipated loss event occurrences, the input information providing a plurality of loss amount thresholds and the frequency of loss event occurrences at the plurality of loss amount thresholds;
an optimization module, operable to generate ALECs based on three or more parameters, the parameters comprising two or more severity parameters from an assumed loss severity distribution and an average loss frequency parameter for the specified time period, the optimization module:
(a) generating one or more initial value sets of the parameters, the initial value sets being provided as pre-determined values and/or provided randomly from a range and/or received manually, the range being pre-determined and/or received manually,
(b) generating an ALEC for each of the value sets of the parameters,
(c) calculating a weighted error test statistic to measure one or more differences at each loss amount threshold, and/or the aggregated differences, between each generated ALEC and the input information,
(d) where one or more of the differences between any one or more of the ALECs and the input information show an improvement in the weighted error statistic greater than a predetermined rate or where steps (b) to (c) have been repeated less than a predetermined number of times, repeating steps (b) to (c) with new value sets of the parameters, the new value sets of the parameters being calculated to attempt to reduce the error test statistic for those ALECs,
(e) determining, from the ALECs not being affected by step (d), the overall best fit ALEC based on the error test statistics calculated in step (c), and
(f) where the differences between the overall best fit ALEC and the input information exceeds a predetermined precision requirement, and where steps (c) to (e) have been carried out less than a predetermined number of times, repeating steps (c) to (e) with a new weighted error test statistic, thereby providing an estimation ALEC;
wherein the estimation ALEC represents one unique combination of the average frequency of loss event occurrences for the specified time period and the parameters of the assumed loss severity distribution that best approximate the input information;
thereby, from the estimation ALEC, the risk of loss may be determined.

2. The computer implemented system of claim 1, wherein the risk of loss for a given level of loss is described in terms of loss frequency information and expressed as the number of expected loss events in for the specified time period, or expressed as the probability of one or more loss events occurring in the specified time period or expressed as the expected time period between expected loss events, the expected time period between expected loss events being expressed as 1-in-N years.

3. The computer implemented system of either claim 1 or 2, wherein the frequency of loss event occurrences is the number of loss event occurrences within an observation period, or the average number of events for the specified time period, or the time period between loss event occurrences expressed as 1-in-N time periods.

4. A computer implemented system of claim 1, wherein the frequency of loss event occurrences is assumed to be Poisson distributed, enabling the determination of the estimated individual loss frequency distribution for the specified time period and the individual loss severity distribution.

5. A computer implemented system of claim 1, wherein severity is assumed to have a normal or lognormal distribution.

6. The computer implemented system of claim 1, wherein the input module is operable to accept hard data, soft data and/or expert opinion.

7. The computer implemented system of claim 1, wherein the optimization module applies a weighted minimum distance analysis routine, thereby exaggerating the test error statistic and placing greater emphasis on the tail portion of the approximated severity distribution.

8. The computer implemented system of claim 7, wherein the weighted minimum distance analysis routine further exaggerates the test error statistic by applying the log value of the aggregated errors.

9. The computer implemented system of either claim 7 or 8, wherein prior to application of the optimization module, loss information collected by the input module is scaled by dividing all losses by the lowest loss threshold, and after application of the optimization module the mean severity parameter is scaled back.

10. The computer implemented system of claim 1, further comprising means for undertaking Monte Carlo based simulation to estimate the aggregated expected loss, and/or the aggregated unexpected loss at a high confidence level.

11. The computer implemented system of claim 10, further comprising means to calculate the aggregated cost of risk and/or risk adjusted profitability and/or economic risk of capital.

12. The computer implemented system of either claim 10 or 11, further comprising means for conducting risk-based decision analysis, the analysis comparing one or more attributes of the estimated ALECs and/or the simulation results derived from the original input information with one or more hypothetical scenarios, and determining the sensitivities of one or more variances in the hypothetical input information and/or parameters and/or other information for the scenarios.

13. The computer implemented system of claim 12, wherein the other information comprises loss amount limits and/or risk tolerance levels and/or cost of capital and/or cost of controls and/or projected benefit/profit and/or cost and coverage of insurance.

14. The computer implemented system of claim 12, wherein the analysis comprises risk-reward analysis and/or risk-control and/or risk-transfer and/or cost/benefit analysis.

15. The computer implemented system of claim 1, wherein the specified time period is one year.

16. A computer implemented method for estimating the risk of loss for a specified time period, the method comprising the steps of:
retrieving and/or receiving manually, input information relating to a plurality of observed and/or anticipated loss event occurrences, the input information providing a plurality of loss amount thresholds and the frequency of loss event occurrences at the plurality of loss amount thresholds;
generating ALECs based on three or more parameters, the parameters comprising two or more severity parameters from an assumed loss severity distribution and an average loss frequency parameter for the specified time period, and optimizing the ALECs by:
(a) generating one or more initial value sets of the parameters, the initial value sets being provided as pre-determined values and/or provided randomly from a range and/or received manually, the range being pre-determined and/or received manually,
(b) generating a ALEC for each of the value sets of the parameters,
(c) calculating a weighted error test statistic to measure one or more differences at each loss amount threshold, and/or the aggregated differences, between each generated ALEC and the input information,
(d) where one or more of the differences between any one or more of the ALECs and the input information show an improvement in the weighted error statistic greater than a predetermined rate or where steps (b) to (c) have been repeated less than a predetermined number of times, repeating steps (b) to (c) with new value sets of the parameters, the new value sets of the parameters being calculated to attempt to reduce the error test statistic for those ALECs,
(e) determining, from the ALECs not being affected by step (d), the overall best fit ALEC based on the error test statistics calculated in step (c), and
(f) where the differences between the overall best fit ALEC and the input information exceeds a predetermined precision requirement, and where steps (c) to (e) have been carried out less than a predetermined number of times, repeating steps (c) to (e) with a new weighted error test statistic, thereby providing an estimation ALEC;
wherein the estimation ALEC represents one unique combination of the average frequency of loss event occurrences for the specified time period and the parameters of the assumed loss severity distribution that best approximate the input information;
thereby, from the estimation ALEC, the risk of loss may be determined.

17. A machine-readable medium having stored thereon data representing sets of instructions which, when executed by a machine, cause the machine to perform operations for estimating the risk of loss for a specified time period, the operations comprising:
retrieving and/or receiving manually, input information relating to a plurality of observed and/or anticipated loss event occurrences, the input information providing a plurality of loss amount thresholds and the frequency of loss event occurrences at the plurality of loss amount thresholds;
generating ALECs based on three or more parameters, the parameters comprising two or more severity parameters from an assumed loss severity distribution and an average loss frequency parameter for the specified time period, and optimizing the ALECs by:
(a) generating one or more initial value sets of the parameters, the initial value sets being provided as pre-determined values and/or provided randomly from a range and/or received manually, the range being pre-determined and/or received manually,
(b) generating an ALEC for each of the value sets of the parameters,
(c) calculating a weighted error test statistic to measure one or more differences at each loss amount threshold, and/or the aggregated differences, between each generated ALEC and the input information,
(d) where one or more of the differences between any one or more of the ALECs and the input information show an improvement in the weighted error statistic greater than a predetermined rate or where steps (b) to (c) have been repeated less than a predetermined number of times, repeating steps (b) to (c) with new value sets of the parameters, the new value sets of the parameters being calculated to attempt to reduce the error test statistic for those ALECs,
(e) determining, from the ALECs not being affected by step (d), the overall best fit ALEC based on the error test statistics calculated in step (c), and
(f) where the differences between the overall best fit ALEC and the input information exceeds a predetermined precision requirement, and where steps (c) to (e) have been carried out less than a predetermined number of times, repeating steps (c) to (e) with a new weighted error test statistic, thereby providing an estimation ALEC;
wherein the estimation ALEC represents one unique combination of the average frequency of loss event occurrences for the specified time period and the parameters of the assumed loss severity distribution that best approximate the input information;
thereby, from the estimation ALEC, the risk of loss may be determined.

18. A computer implemented method for estimating the risk of loss for a specified time period, the method comprising the steps of:
retrieving and/or receiving manually, input information relating to a plurality of observed and/or anticipated loss event occurrences, the input information providing a plurality of loss amount thresholds and the frequency of loss event occurrences at the plurality of loss amount thresholds;
generating one or more ALECs based on three or more parameters, the parameters comprising two or more severity parameters from an assumed loss severity distribution and an average loss frequency parameter for specified time period; and
optimizing the ALECs by choosing an estimation ALEC from the one or more ALECs, wherein the estimation ALEC represents one unique combination of the average frequency of loss event occurrences for the specified time period and the parameters of the assumed loss severity distribution that best approximate the input information;
wherein the risk of loss is determined from the estimation ALEC.
